(19) United States
(12) Patent Application Publication
(10) Pub. No.: US 2007/0038476 A1
(43) Pub. Date: Feb. 15, 2007

(54) System, method, and computer program product for medical treatment

(75) Inventor: Andrew Sternlicht, Chestnut Hill, MA (US)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Hotelrecovery, Inc., Newton, MA (US)

(21) Appl. No.: 11/584,182

(22) Filed: Oct. 20, 2006

Related U.S. Application Data
(62) Division of application No. 10/067,087, filed on Feb. 4, 2002.
(60) Provisional application No. 60/266,139, filed on Feb. 2, 2001.

(51) Int. Cl. G06Q 10/00; G06F 9/44

(52) U.S. Cl. 705/2; 705/7

(57) ABSTRACT

A client care method, system, and computer program product which provides a package of accommodation, concierge, and/or clinical services to clients outside of a medical facility. The clients may be bundles to share service providers at the same geographic location.

### RELATED APPLICATIONS

This application claims priority under 35 U.S.C. § 119 to U.S. Provisional Patent Application Ser. No. 60/266,139 filed Feb. 2, 2001, the disclosure of which is incorporated herein by reference in its entirety.

### BACKGROUND OF THE INVENTION

This invention relates to a method, a system, and a computer program product for medical treatment and recovery outside of a hospital. Typically post-procedure recovery facilities provide a middle ground between hospitalization or direct physician supervision in an office or surgery center facility and limited or no medical supervision or help in one's own home. Some hotels serve individual clientele with standard hotel services post-surgery, and allow in-room nursing provided by the individual. Post-surgical recovery in a hotel is usually set up by the individual patient or through a hospital's international office for international patients who may not be able to travel home directly after their medical procedure. In such cases, a nurse must be hired full-time to provide the individual patient in the hotel continuous nursing. Thus, there is one nurse for only one person in the hotel. Furthermore, each additional therapy or amenity services must be scheduled individually with a separate service organization. Thus, a separate organization must be contacted for each individual service desired. For example, separate organizations must be contacted to negotiate pricing and schedule of services, such as, medication, follow-up physician orders, transport, accommodations, clinical care, food and dietary needs, amenities such as massage or spa services, and family concerns. This large task must be undertaken by the recovering patient, busy local doctor, or typically distant family members.

### SUMMARY OF THE INVENTION

Various embodiments of the present invention provide certain advantages and overcome certain drawbacks of the conventional methods and systems. This being said, the present invention provides numerous advantages, including the advantage of improving the level of care and recovery of the patient, improving a patient's amenities during the recovery period, improving and increasing the number of service locations for patient recovery, decreasing costs for patient recovery and care, and increasing information access.

Further features and advantages of the present invention are described in detail below with reference to the accompanying drawings.

### BRIEF DESCRIPTION OF THE DRAWINGS

Various embodiments of the invention will be described, by way of example, with reference to the accompanying drawings in which:

FIG. 1 is a flow chart describing the method in one embodiment of the present invention;

FIG. 2 is a data flow diagram of an example medical treatment system of the present invention;

FIG. 3 is a flow diagram of services of an example medical treatment system of the present invention;

FIG. 4 is a diagram of an example client care processor;

FIG. 5 is a diagram of an example table for a database of patient information;

FIG. 6 is a diagram of an example table for a database of referral source information;

FIG. 7 is a diagram of an example table for a database of services information;

FIG. 8 is a diagram of an example table for a database of product information;

FIG. 9 is a diagram of an example table for a database of default treatment information;

FIG. 10 is an example referral source information template;

FIGS. 11A and 11B are an example default clinical protocol;

FIGS. 12A-12E are an example default clinical procedure;

FIG. 13 is an example template for recording travel concierge services;

FIG. 14 is an example template for recording accommodation information;

FIG. 15 is an example template for recording reservation information;

FIGS. 16A and 16B is an example template for recording reservation information;

FIG. 17 is an example template for recording physician instructions;

FIG. 18 is an example template for recording medication instructions and provision;

FIGS. 19A and 19B are an example template for recording patient intake information;

FIG. 20 is an example template for recording concierge services information;

FIG. 21 is an example template for recording client vital signs;

FIG. 22 is an example template for recording client intake and output;

FIG. 23 is an example template for recording time for nursing services;

FIGS. 24A-24E is an example template for recording provision and assessment of therapy services;

FIG. 25 is an example template for recording time for therapy services;

FIG. 26 is an example template for recording physician instructions and/or assessment;

FIG. 27 is an example template for recording client medical history and/or assessment information;

FIGS. 28A and 28B is an example template for recording patient information from an initial visit; and

FIG. 29 is an example template for recording client progress information.

### DETAILED DESCRIPTION

Current options for care of a patient after discharge from a hospital are typically ad-hoc or fragmented options. This is a stressful and cumbersome process for the hospitalized patient or the family support system. Furthermore, in view of cost control measures from insurance companies and medical service providers, patients are often discharged from the hospital as soon as possible, often before the patient is able or willing to take care of himself/herself. Patients may even be discharged from a hospital into interim care to free space in a hospital for patients requiring a high level of care. Transition from the hospital directly to a home environment is traumatic both for the recovering patient as well as the family that is expected to help and support the discharged patient. Moreover, the discharged patient is sometimes in excessive pain and discomfort and is daunted by the difficulty in maintaining post-discharge care and in returning to the doctor or hospital for follow up visits. Thus, discharged patients often fear discharge from the hospital almost as much as they fear the actual medical procedure itself. Low compliance with discharge instruction often results from the instructions being delivered to the patient and family at a point in time when they are under stress and will have poor recall. This lack of supervised post-procedure care often leads to extended or incomplete recovery, complications, or even relapse. Furthermore, the burden on family and friends to support a disabled and homebound recovering patient may be excessive or impossible in particular situations.

Post-medical procedure recovery facilities can be made more accessible to consumers through bundling services for multiple patients from multiple doctors and by increasing the availability of these services and the number of locations in which they are offered while decreasing complication rates. Ease of access and availability is further improved with packaging clinical services with the hospitality industry including accommodation and concierge services from a single source to encompass the different types of services that might be required or desired to cater to and treat the patient. Moreover, bundling after-care services for multiple clients allows the clients to ‘share’ the time and costs of service personnel or receive discounts based on typically individual services provided as a group or closely accommodated clients. For example, the bundle client group may receive a discount on the room accommodations and may share the time and costs of a single duty nurse, which allows for many costs savings over reserving these types of services individually.

It should be noted that the term “client” and the term “patient” are used herein to indicate an individual or group desiring or receiving at least one of accommodation services, concierge services, and clinical services as described further below. It should also be noted that the term “package” describes offering any combination of various accommodation, concierge, and clinical services from a single source. The term “bundle” describes offering services to multiple clients such that the same services and/or service providers support multiple patients. For example, a package of ucc/conc/cl services may be offered to clients. If the clients are proximate one another, then these clients may be bundled. The services and/or service providers are then shared among the bundled clients.

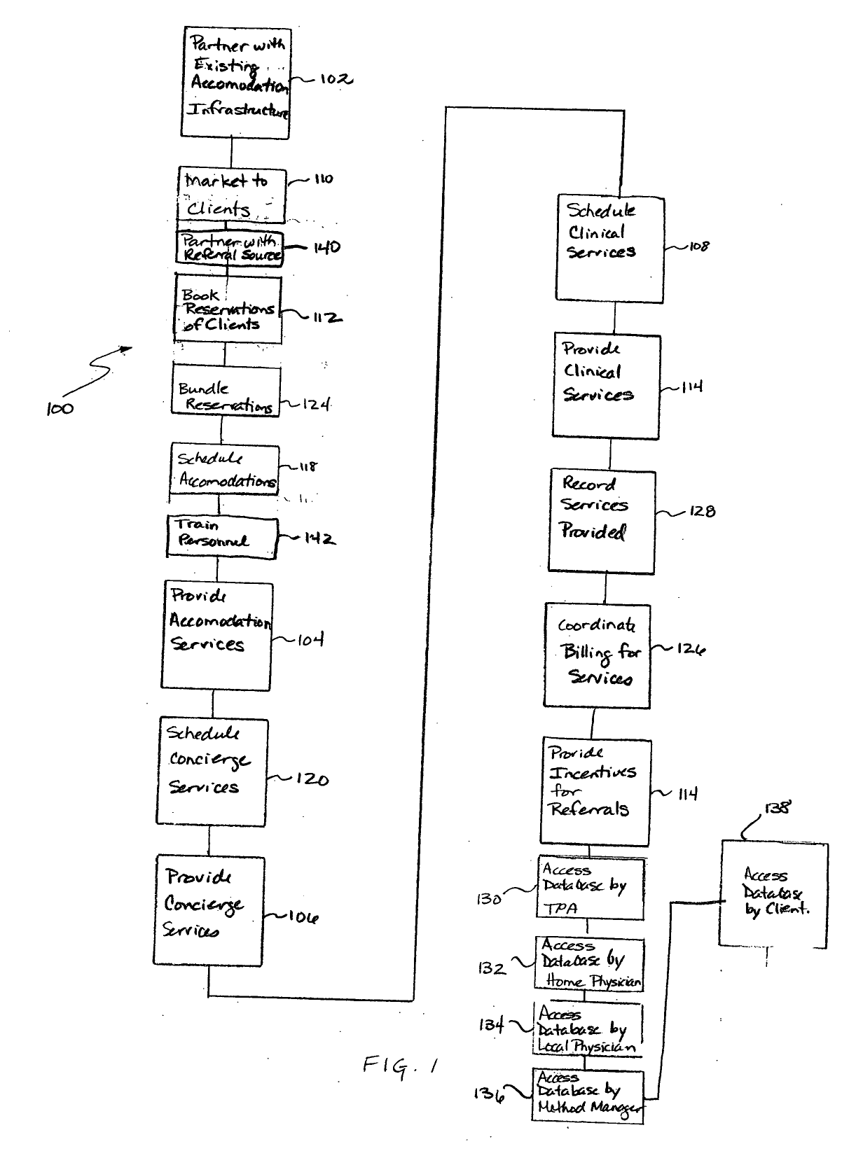

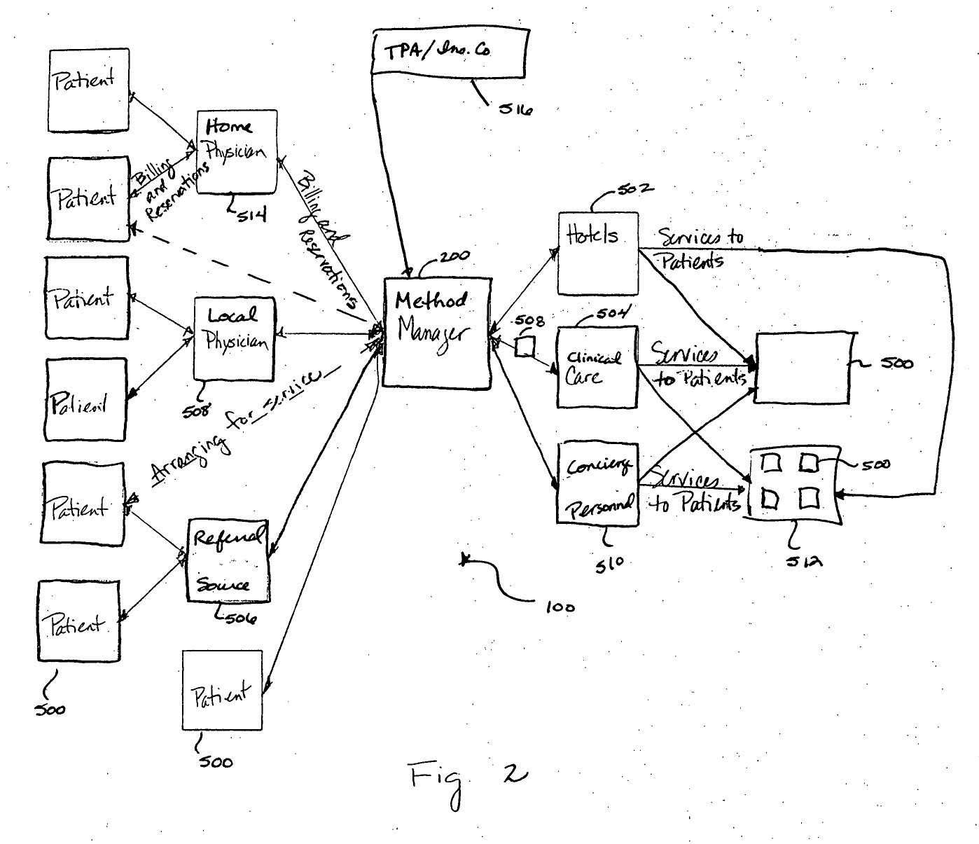

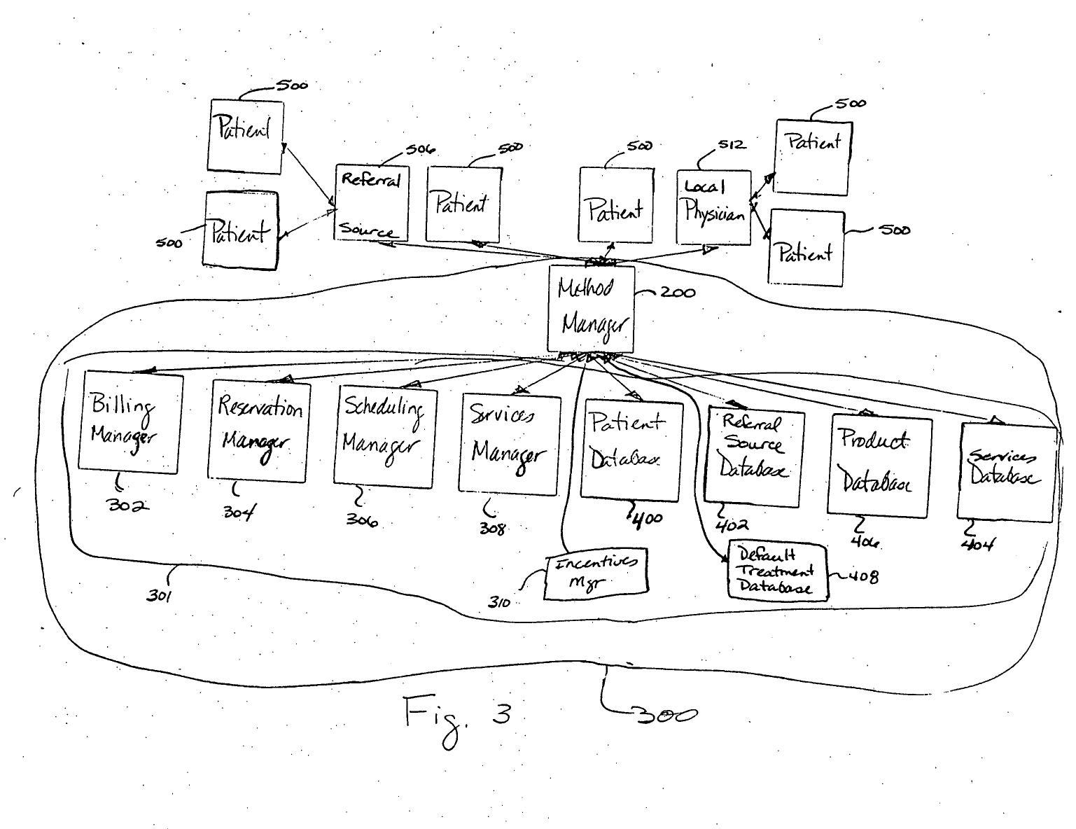

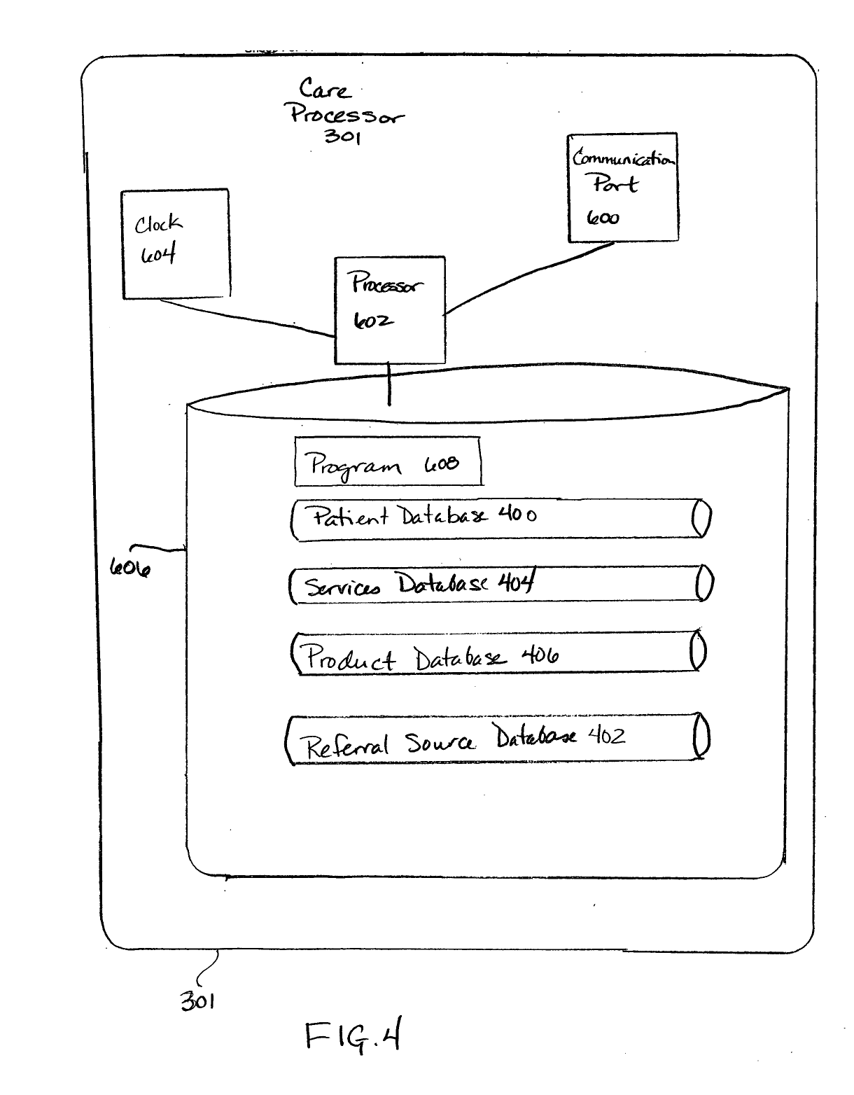

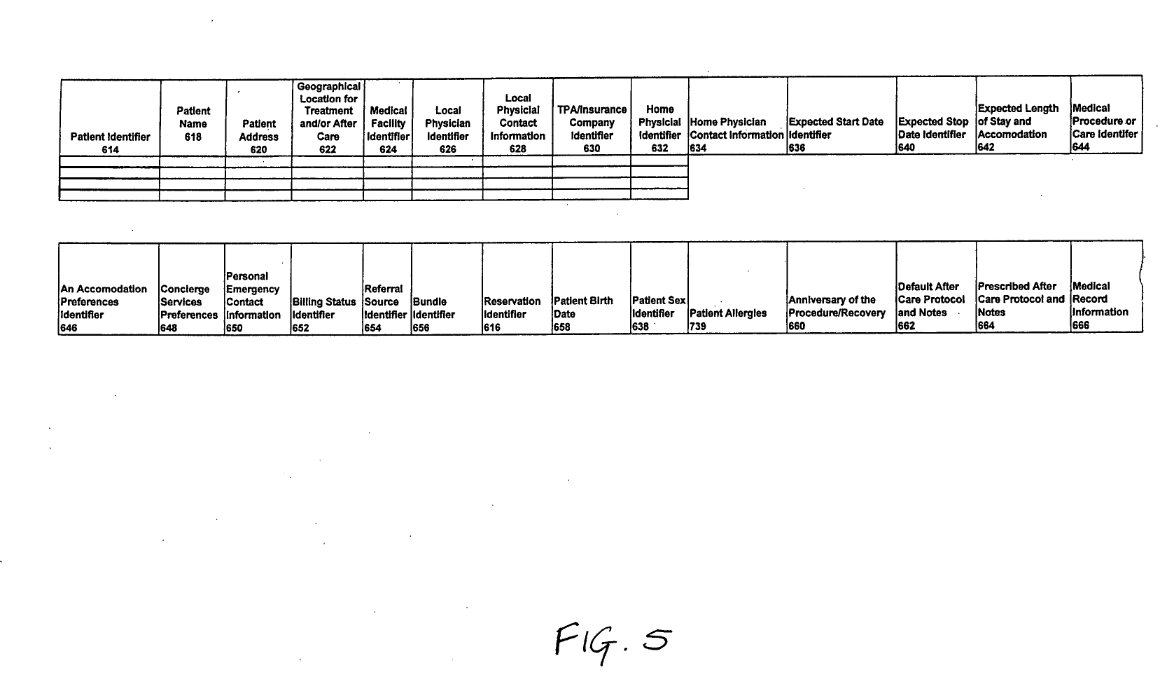

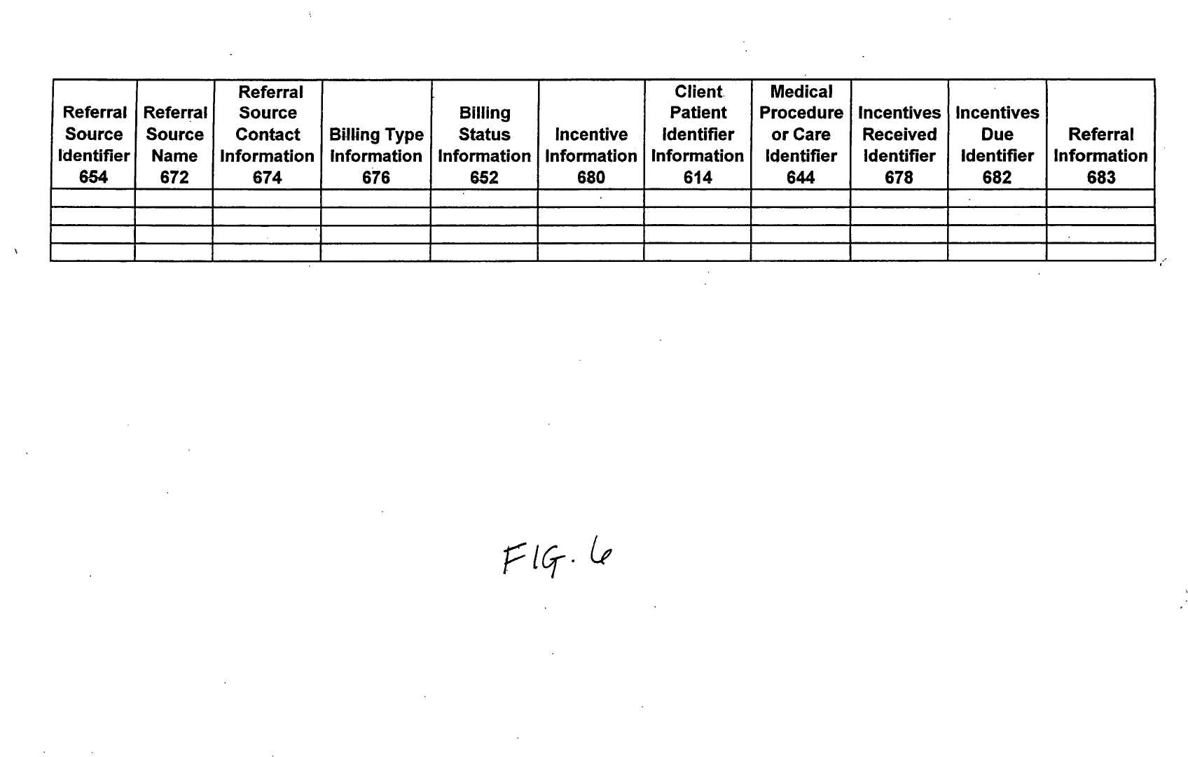

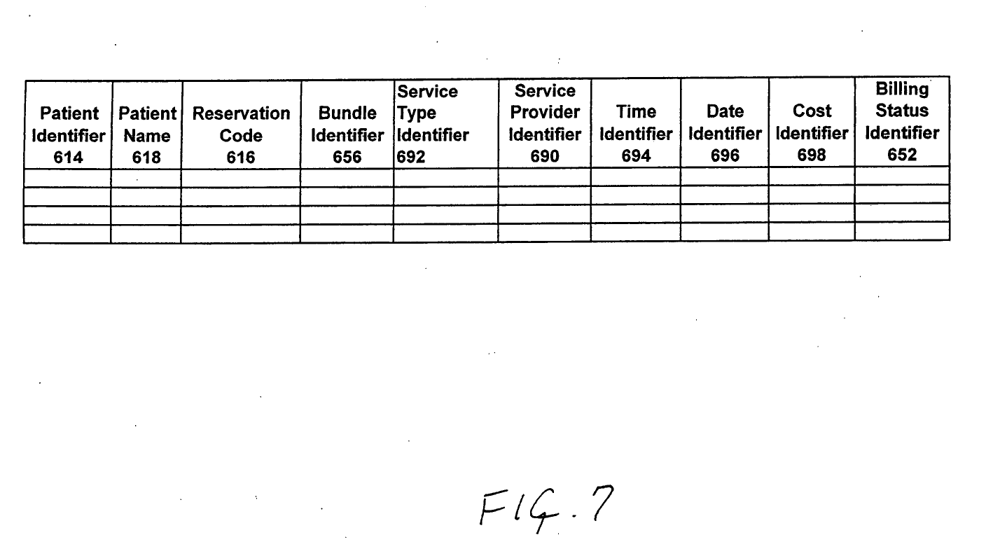

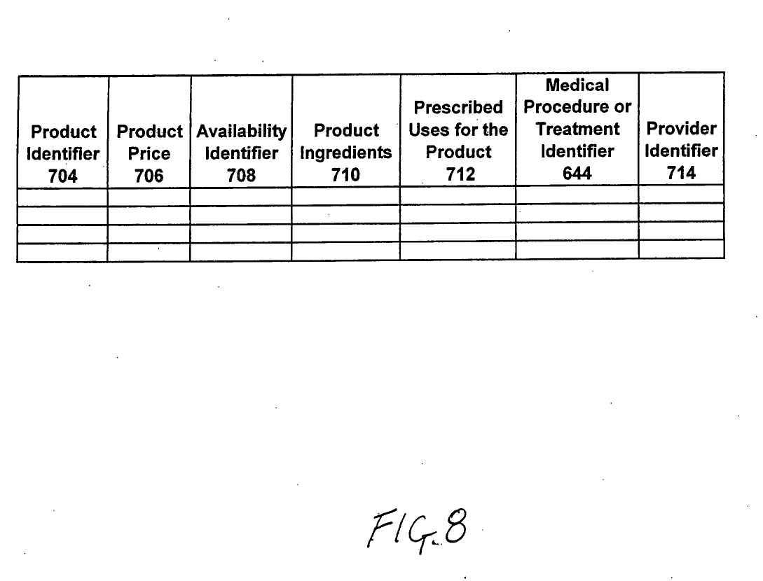

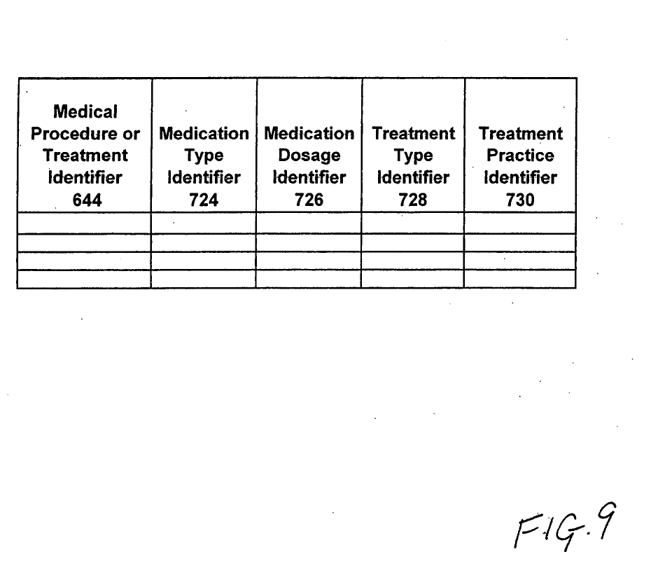

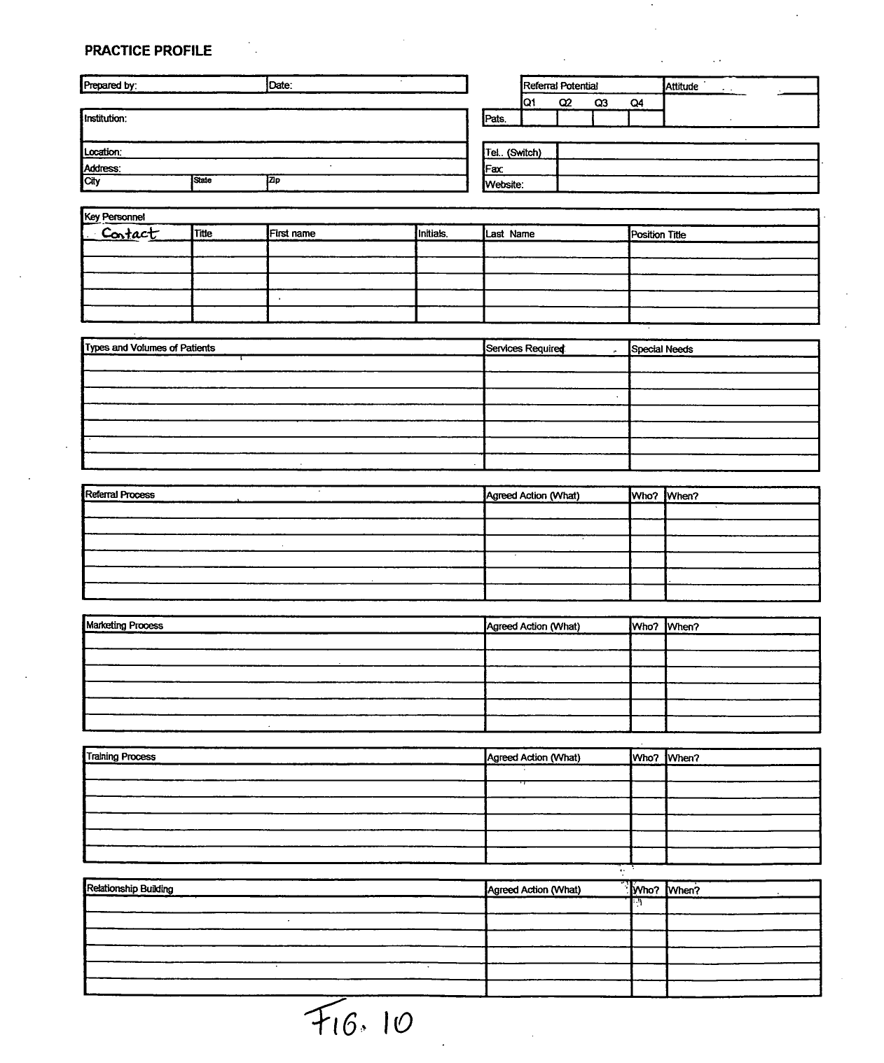

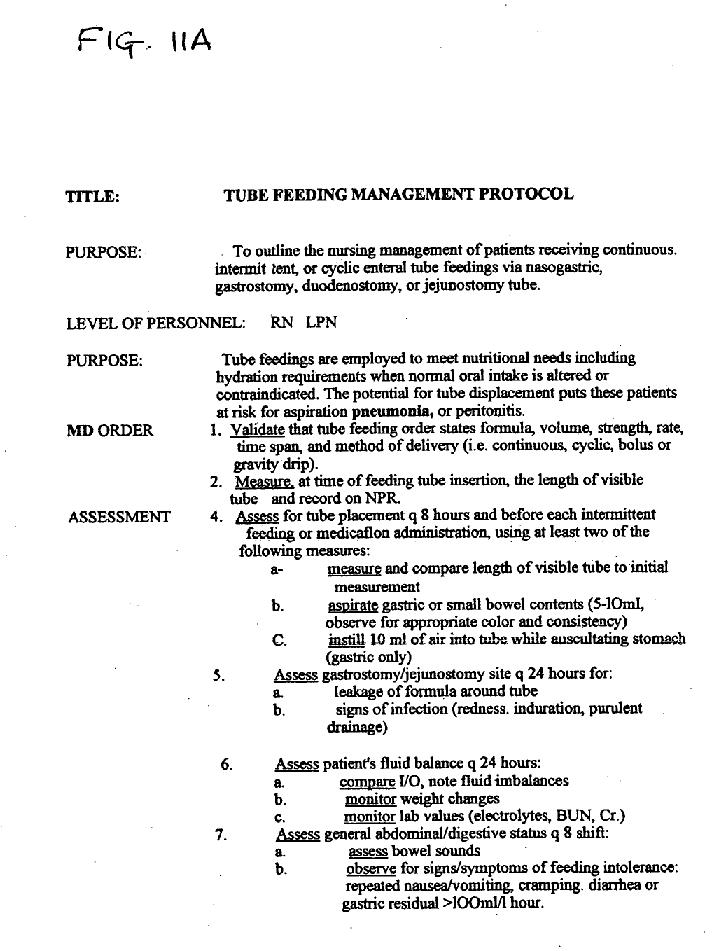

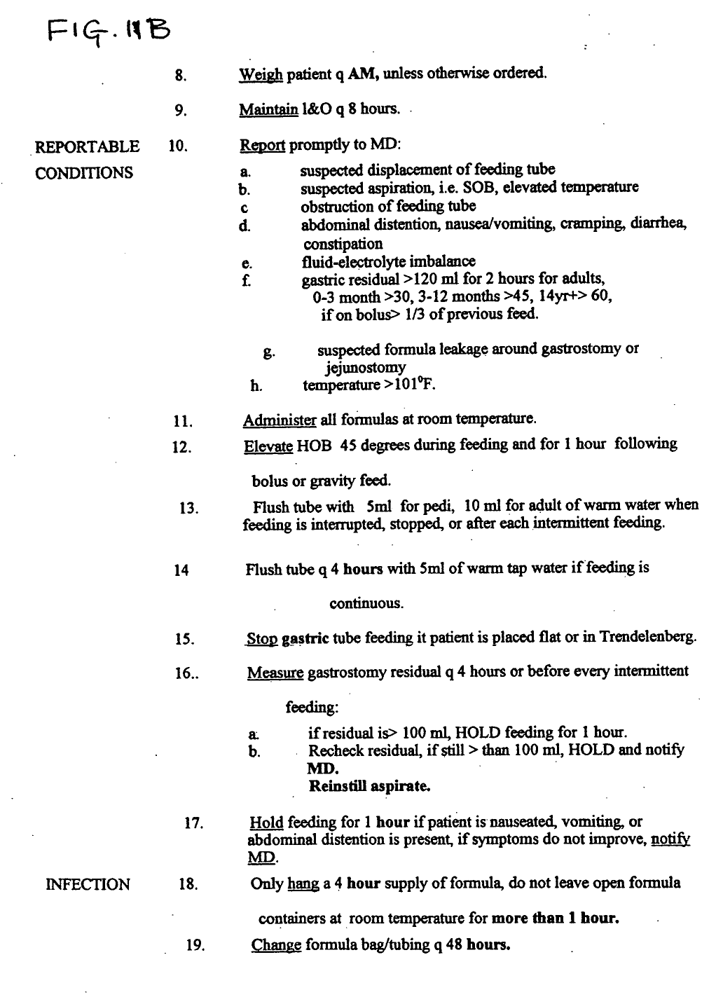

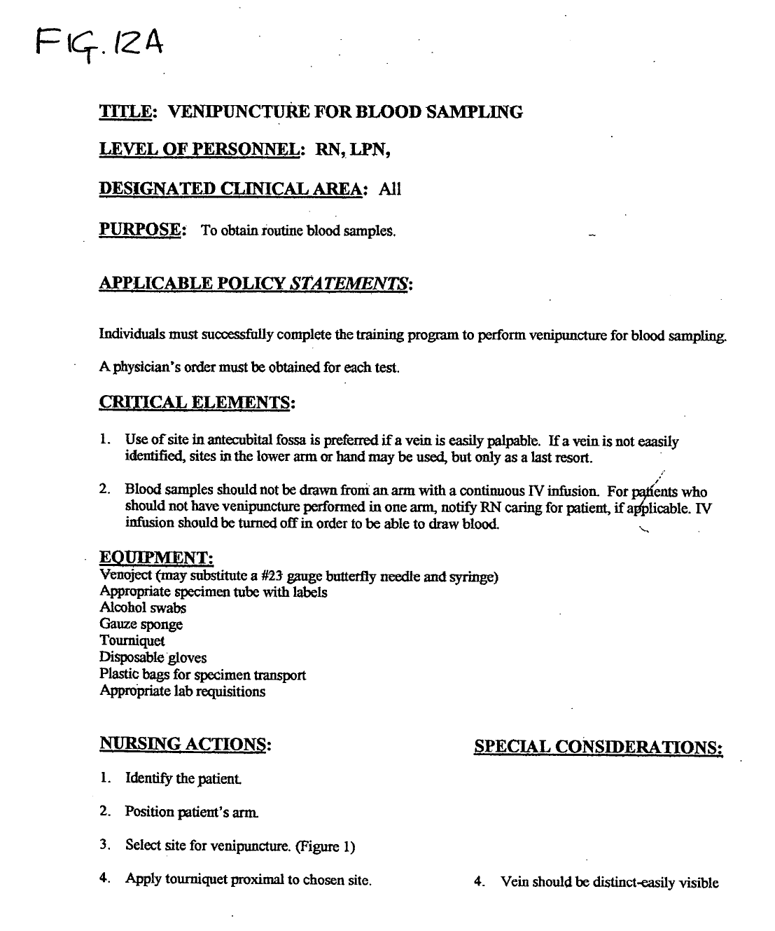

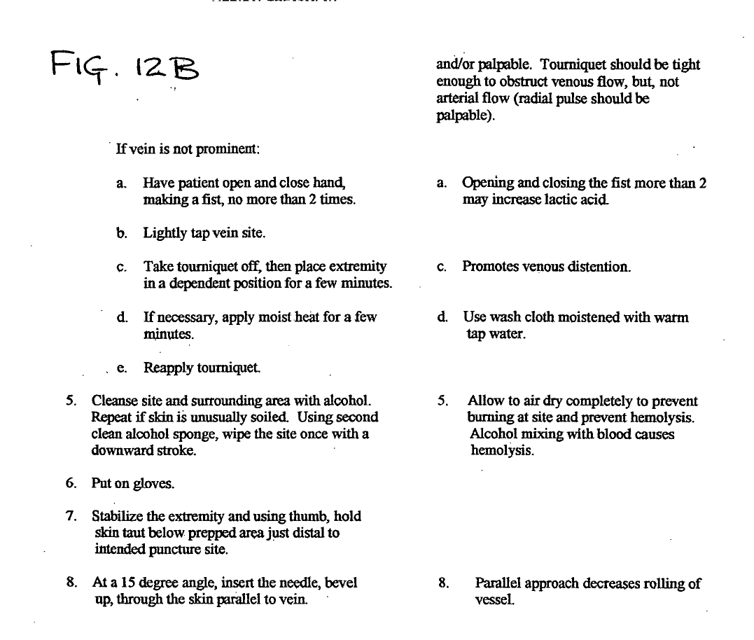

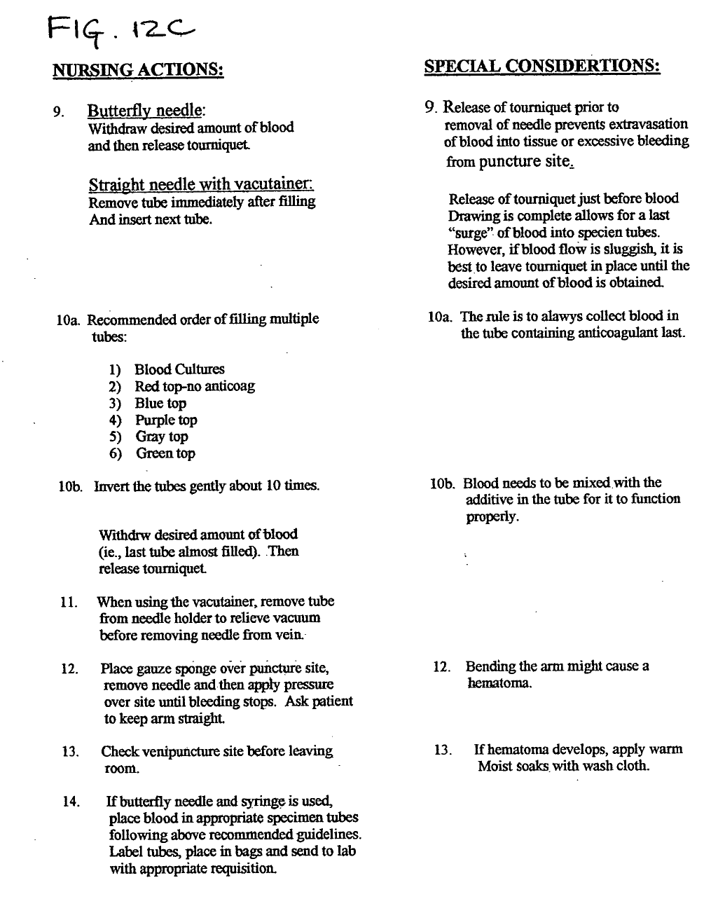

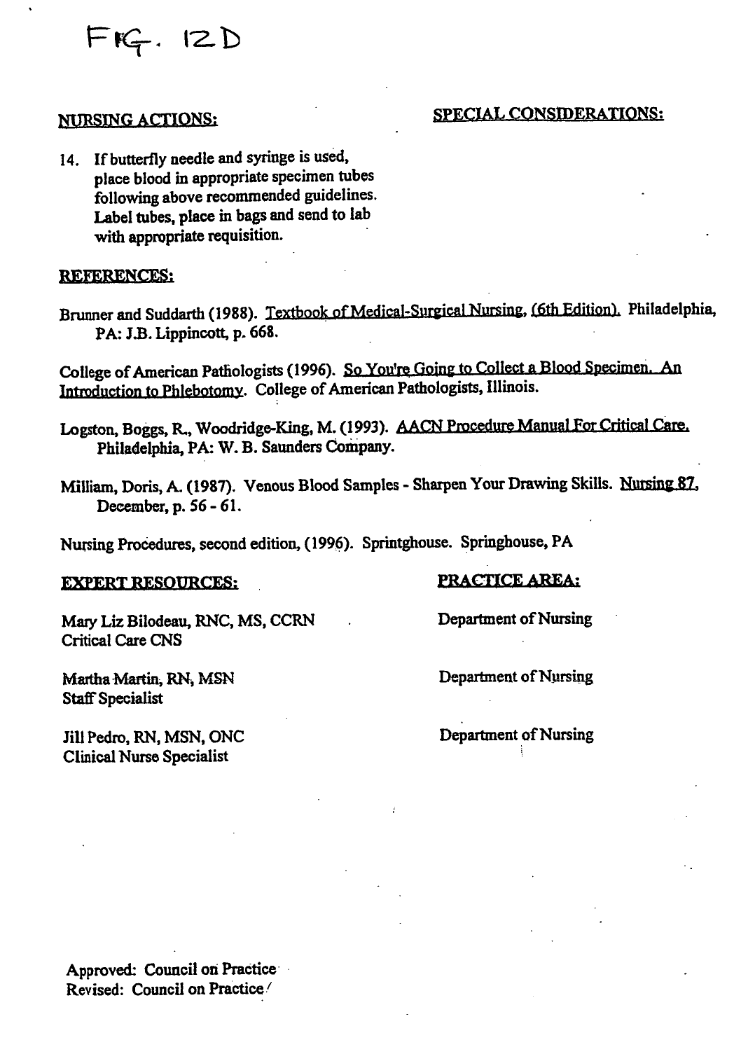

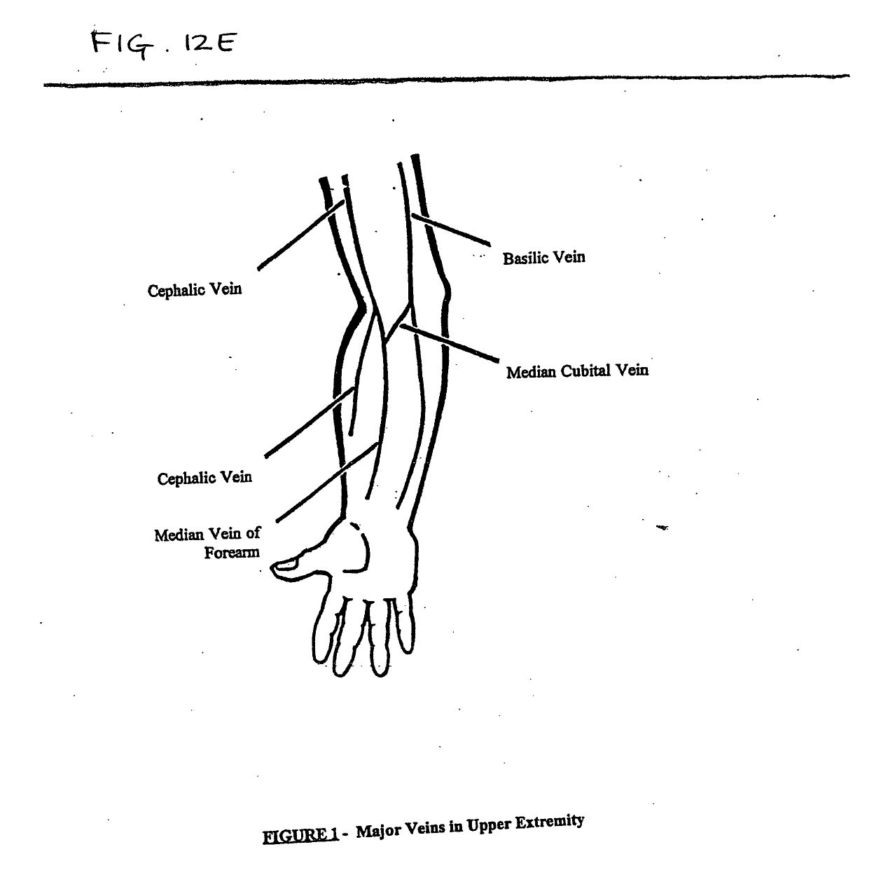

FIGS. 1 and 2 illustrate an example post-procedure recovery business method 100 providing a package of post-recovery services, including, but not limited to, clinical services, accommodation services, and concierge services. Although the steps of the method are described in a particular order, the various steps need not be performed sequentially or in the order described.

The method may take advantage of some or all of the typically non-medical accommodation infrastructure that is already in place with short term guest based accommodations, including hotels, motels, bed and breakfasts, and short term leased apartments, and in a preferred embodiment, luxury hotel accommodations. The method then packages a program of additional services for the post-medical procedure, recovery and/or treatment of a patient. The method allows rapid expansion opportunities, limited start-up costs, and tailored response to customer demand by utilizing existing hotel infrastructure and providing a variety of packages and/or bundled services. The method may be applied to any medical patient requiring or desiring a level of medical care.

The end client or patient 500 may be a targeted segment of those needing or desiring post-procedure care. More preferably, the targeted segments may define customer and physician bases, including, but not limited to, cosmetic and reconstructive surgery, orthopedic, neurosurgical, post cardiology or cardiac surgery, oncology, chronic debilitating illnesses, pediatrics, and post-obstetric procedures and/or hospital stays. In one embodiment, the client may require long term or interim care, such as a convalescing patient who normally would not be discharged from a hospital setting without full nursing care. In some cases the accommodations in a non-medical facility outside of the patient's home may improve recovery and/or produce a higher cure rate. For example, the home environment may be part of the problem for some pediatric ailments, such as those with psychological and/or behavioral components, such as complex regional pain syndrome and neuropathic syndromes. These aliments may be better treated outside a medical facility and outside the patient's home, but nonetheless, treated with a coordinated medical, psychological, and therapeutic protocol.

The end client or patient may desire particular concierge or accommodation services of a higher level of luxury and/or availability than is currently available in typical hospital settings. Moreover, end clients may also wish to accommodate family members for family respite before the procedure, during the procedure, and/or after the procedure during the treatment and/or recovery; accommodate business equipment, amenities, and/or personnel; and/or accommodate visitors.

Management of the hotel-based recovery and/or treatment by a method manager 200 may be centralized and/or packaged to improve the care level and location of services available to patients and their care-givers, streamline scheduling, improve information access, improve patient satisfaction, improve patient post-surgical care and recovery, and/or reduce costs. The method allows the method manager to service multiple patients from multiple physicians with a bundle of services, such as one nurse for overseeing multiple patients. The method also decreases work load of scheduling and providing after-care services by providing a package of accommodation, concierge, and/or clinical service which may be individually tailored for clients.

In one embodiment as viewed in FIG. 1, the method 100 includes a step 102 of negotiating or creating agreements with at least one short term guest based accommodation, including, but not limited to a hotel, motel, bed and breakfast, short term lease apartments, which hereinafter will be summarized with the term “hotel”. The hotel 502 may be multiple hotels owned by different owners, may be a line of hotels owned and/or managed by a single corporate owner/manager, and/or short-term rental apartments, for example. The hotels and the manager of the method may provide a variety of goods and services to the patient, including accommodation services at step 104, concierge services at step 106, and clinical services at step 108. Alternatively, or additionally, the accommodation services may be provided within the client's own home to increase patient comfort and accommodate client family and/or needs or desires.

The infrastructure of the accommodations, which is a hotel in one embodiment, provides access to temporary accommodation rooms for the patients at step 104. These typical hotel rooms with bed, bathroom, telephone, television and sitting area may be modified to make hospital-type beds available which may be purchased or leased by the manager of the method or provided by the hotel. The hotel or method manager may also temporarily or permanently convert the rooms to include medication and supply storage, communication devices and/or holders such as laptop computers or palm computing devices and docking stations, shampoo and hair care adapters for sinks/bath tub for disabled patients or patients have undergone facial surgery, medical and monitoring equipment, and/or disposal systems/containers for hazardous materials such as dressings, medication dispensers, medical waste, and linens. In one embodiment of the invention, luxury hotel rooms may be provided to all clients or only to those clients desiring luxury and/or high-end service accommodations. Many of these modifications, such as medical waste containers, may be provided in each individual room, while others, such as medical and monitoring equipment and wheelchairs, may be bundled or accessible to multiple patients. The equipment may include, but is not limited to, EEGs, EKGs, blood pressure cuffs, thermometers, heart rate monitors, oxygen monitors, defibrillators, stethoscopes, surgical dressing care supplies, catheter sterile site dressing/cleaning kits, gloves, alcohol and Betadine, pulse oximeter, tracheotomy care kit, ostomy care kits, orthopedic beds, orthopedic medical supplies, canes, wheelchairs, walkers, assist devices, resistance training devices, spirometers, orthopedic supplies (splints, Ace wraps, Kerlix sponges), continuous passive movement machines, egg crate mattresses, blood drawing supplies, specimen kits, insulin syringes, and other equipment typically found in a doctor's office, clinic or hospital setting or required for a particular patient.

Partnering with an existing hotel infrastructure immediately expands availability of spaces for treatment and/or recovery of patients. The hotel infrastructure may be flexible in terms of temporarily accommodating a varying number of patients on different dates. Additionally, short-term rental apartments may be provided to augment an existing hotel infrastructure, accommodate individual patient and family support needs, and/or accommodate a patient requiring a longer recovery period. Bundling the accommodation services outside of the medical environment of a hospital or clinic taps into an existing infrastructure of short-term room availability on a flexible basis.

The hotel and/or the manager of the method may provide a variety of concierge services to the patient at step 106. These services may be provided individually to the patient on demand by the hotel as with typical hotel clients, bundled through an agreement between the multiple patients and the method manager, packaged through an agreement between a single patient and the method manager, or bundled through an agreement between the method manager and the hotel. Concierge services provided by concierge personnel 510 may include hair dressing and salon services, restaurant and dining services, twenty four hour room service, interpreter and translation services, valet services, personal shopper, personal or business assistant, entertainment devices such as video tape players, videos, DVD players, DVDs, and video games, telephone and facsimile services, cellular phone and Internet access, masseuses, cosmetic spa services including facials, manicures, and pedicures, airport meet and greet assistance, ambulance services, and/or limousine and/or wheelchair van transportation.

The method manager may coordinate and/or provide travel accommodations and reservations, including air travel and vehicle travel to and from the physician's office for pre- and post-procedure visits, as well as initial and final travel from and to the patient's residence. These travel accommodations may include commercial or chartered air travel, personalized and confidential limousine transport, medical escorts for travel, or bundled travel services for multiple patients traveling to or from the same medical facility, travel way-stop, or medical facility.

Often a medical facility will not discharge a patient into his own care, requiring a member of the patient's family or medical escort to accompany the patient and accept responsibility for the patient at discharge. The method manager may provide the clinical services, described further below, including trained medical escorts to escort the patient. The medical escort services may be provided packaged with concierge transportation services or as desired by the patient to assist the patient in their travel and/or discharge from the medical facility. The medical escort may be required and/or desired for only the transportation from the medical facility to the patient's destination, such as the accommodations under the method. Additionally, the medical escort may accompany the patient during all or selected phases of the travel of the patient from the patient's home to the medical facility, at the medical facility for the duration of the patient's stay, from the medical facility to the method accommodations, from the method accommodations to the patient's home, and/or for a period of time in the patient's home. The medical escort may also provide concierge services to the client, during travel, such as reserving the travel services and organizing the luggage, food, and/or customs check in.

Moreover, the medical escort and/or travel services may be provided as a loss leader or feeder for the other services provided under the method. For example, the travel and/or medical escort services may be provided at near cost to attract consumers to the services offered by the method manager. After the consumer has scheduled the desired travel services, they may be tempted by the various other services offered and schedule those as well. This method of marketing and packaging services may be applied to any combination of the services offered by the method manager.

The method also provides a variety of individual and bundled clinical services to the client (the medical patient) at step 108. Some or all of these clinical services may be tailored to individual clients receiving the accommodation and/or concierge services. Additionally or alternatively, the clinical services may be bundled and provided to multiple clients staying as a group and receiving the accommodation and/or concierge services.

These services may include, but are not limited to, private duty nursing in the hospital, at the provided accommodations, and/or patient home. The nursing services are preferably bundled such that a single clinical personnel 504 will provide clinical services for more than one client, and more preferably for more than one patient at the same location. Clinical personnel 504 are well known in the art and include, but are not limited to, duty nurses, registered nurses (“RNs”), Licensed Practical Nurses (“LPNs”), home health aides (“HHAs”), attending physicians, consulting physicians, physical therapists, rehabilitation therapists, aestheticians, and specialized nurses including cardiac, and orthopedic. In addition to providing clinical services to the client, the clinical personnel may also augment or solely provide the concierge services discussed above. For example, the duty nurse caring for a patient may also provide patient advocacy as well as schedule and/or provided concierge services for the client.

The clinical personnel 504 is preferably provided by the method manager 200 to work within a particular location for multiple patients to bundle the packaged services provided by the method manager. The clinical personnel may be free-lance, provided by a staffing service, on staff at the method manager, or may be on call by the method manager. In one embodiment of the invention, the method manager controls or has access to a clinical staffing service to provide the duty nurses and/or other specially trained personnel administering the clinical services.

The duty nurse or specially trained personnel may also provide individual or bundled services for patients at the same or different locations. The clinical services include assessment of the patient, teaching and training, documentation, reporting, and discharging services.

The assessment of the patient includes assessment of the appropriateness for care and additional or less services as scheduled; client medical status including a complete and/or update to the client's health history and/or a physical and/or a social assessment of the client; existing support systems for the client, finding sources for the client, equipment and supplies; and the environment including safety, sanitation, and handicap accessibility as needed.

The training services may be provided to teach the patient, teach the family and/or teach or train the clinical personnel to provide or augment medical training, such as specific medical procedures and/or cultural training to service clients with special needs.

The documentation services include a review of the patient chart for scheduled and necessary medical procedures and protocols including an assessment admission and discharge instructions, informed consent forms, verbal orders, emergency responses to patient status, charting of acute and/or chronic issues, all teaching provided to the patient and patient's family and/or home support, and all assessment of medical and non-medical needs of the patient.

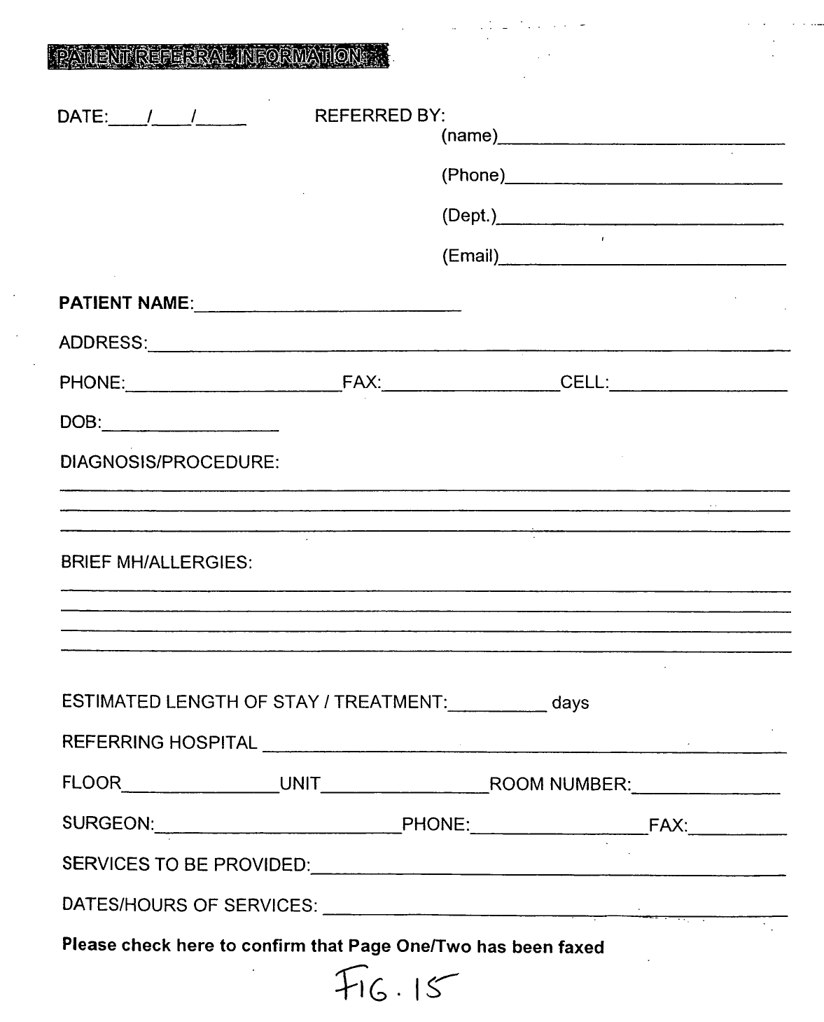

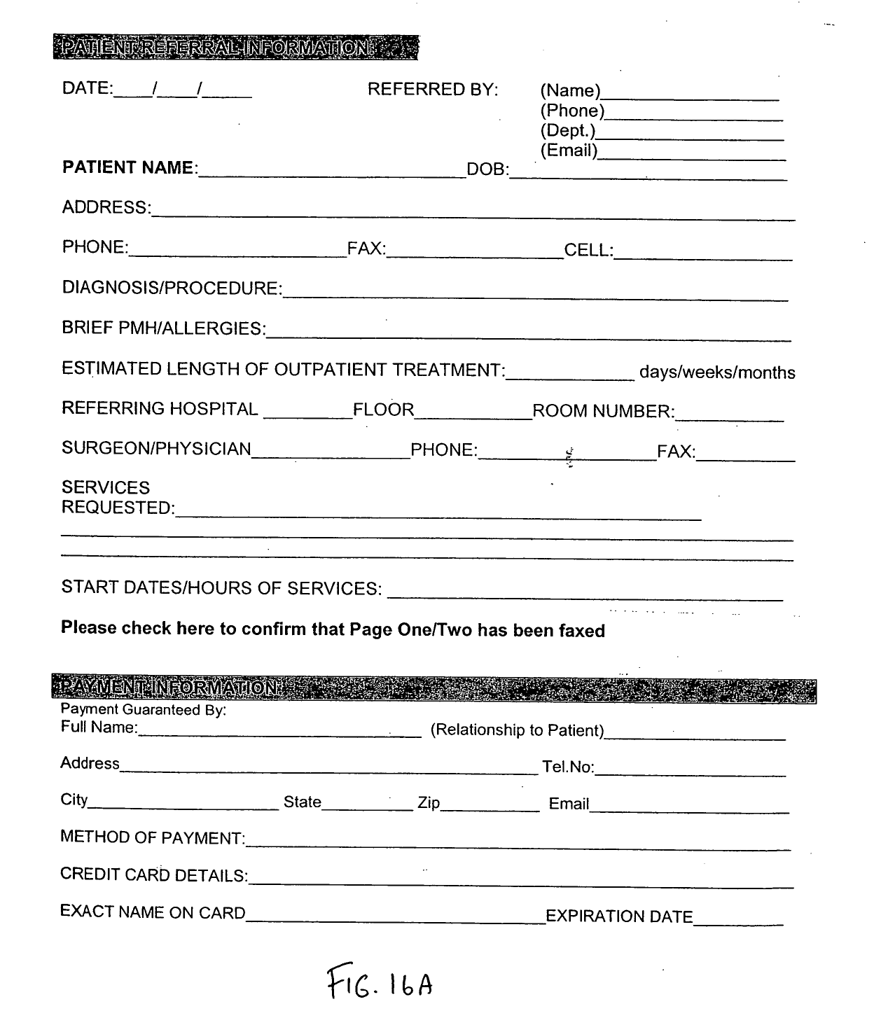

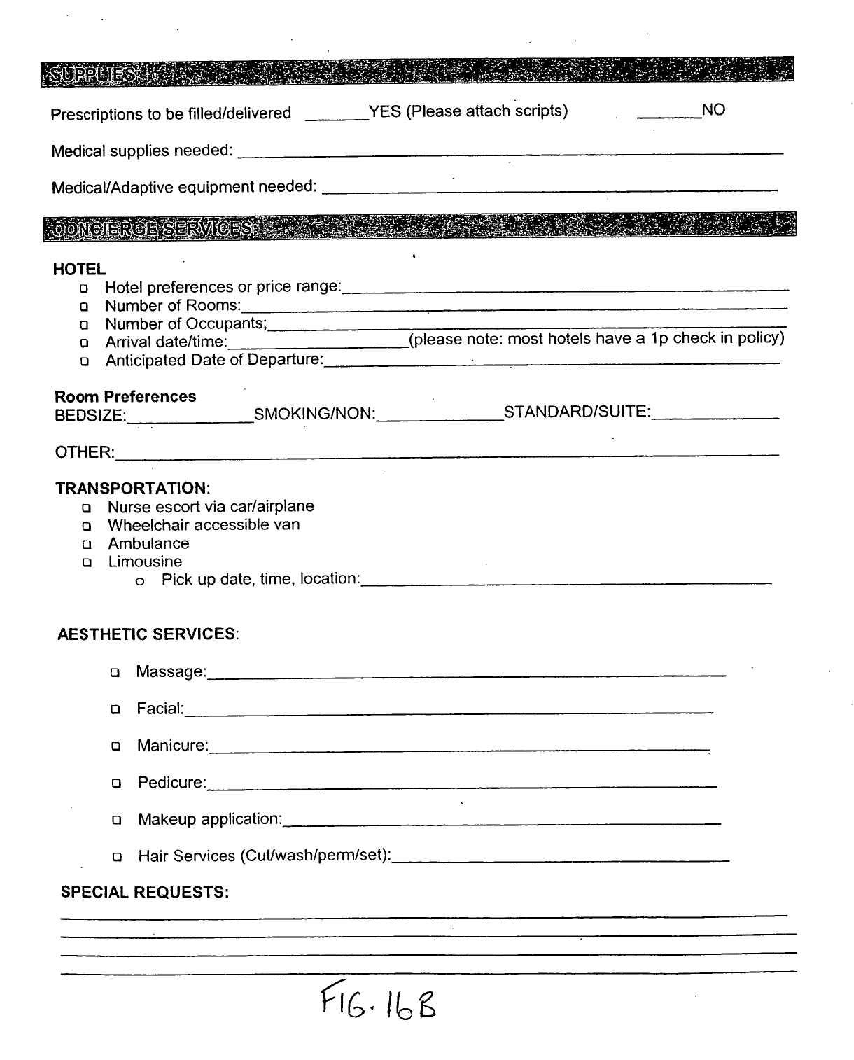

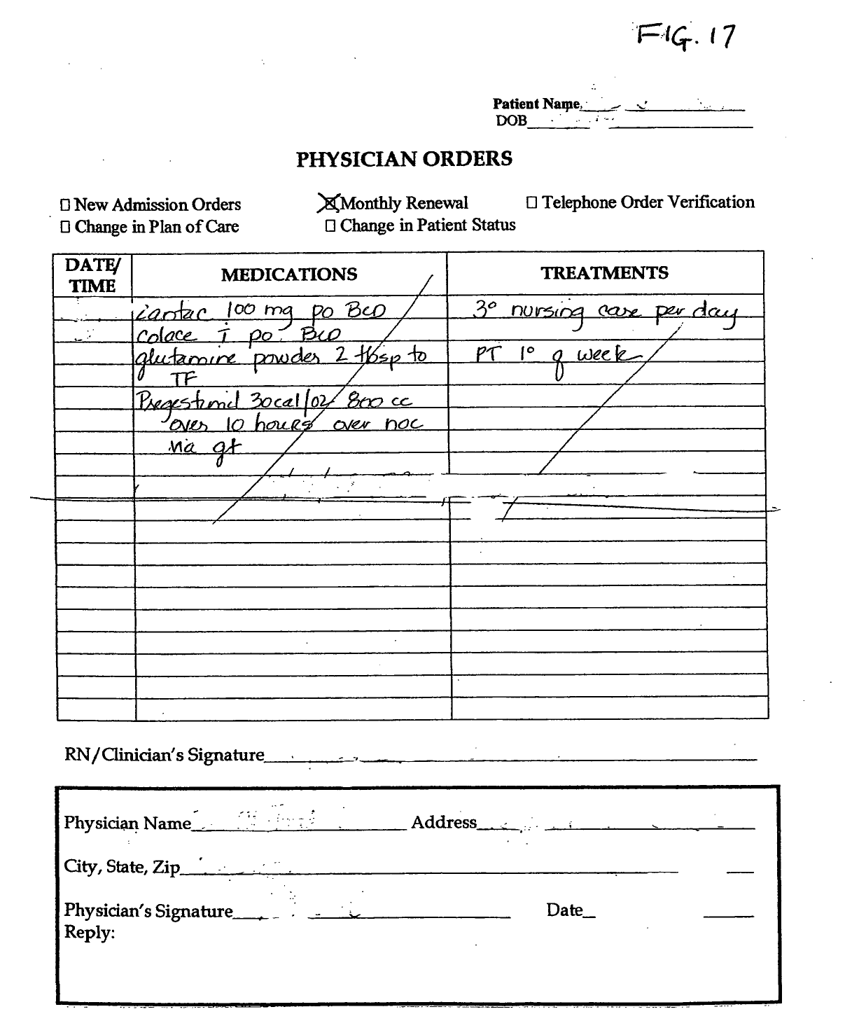

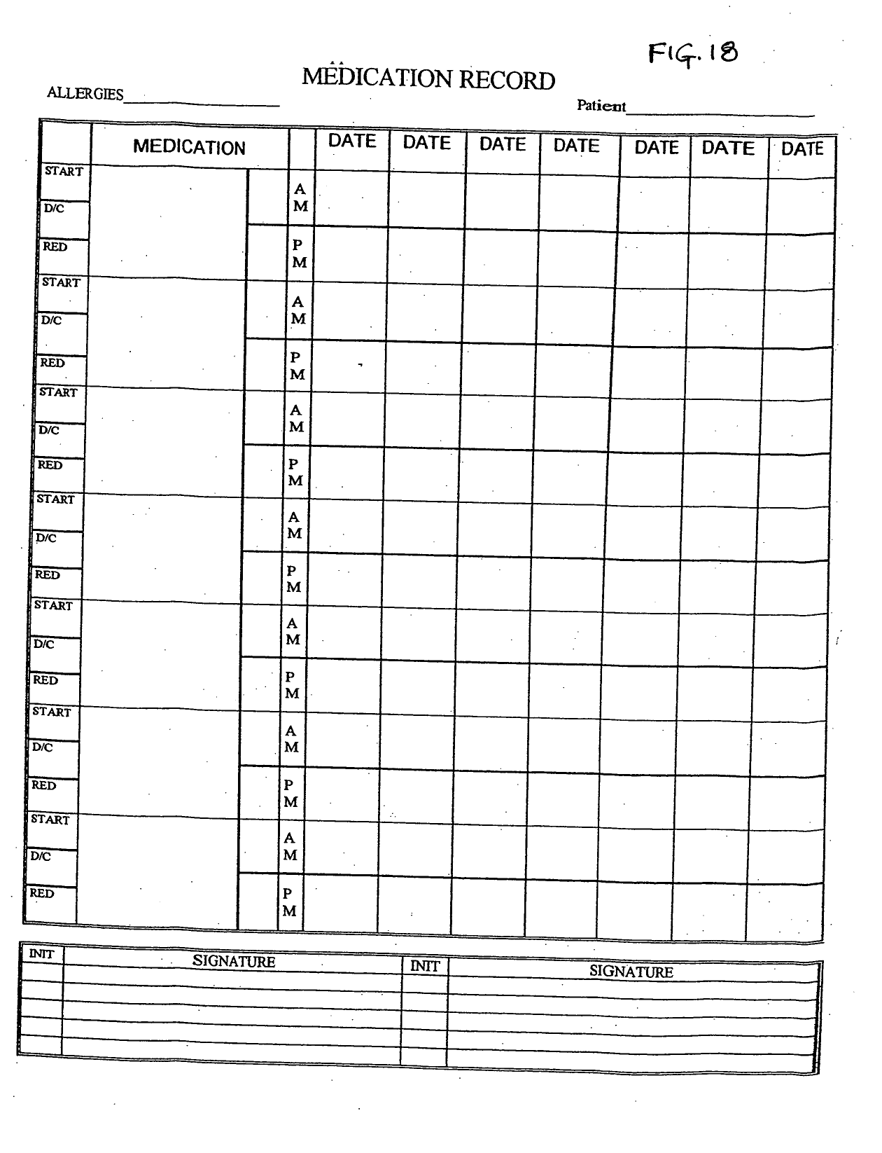

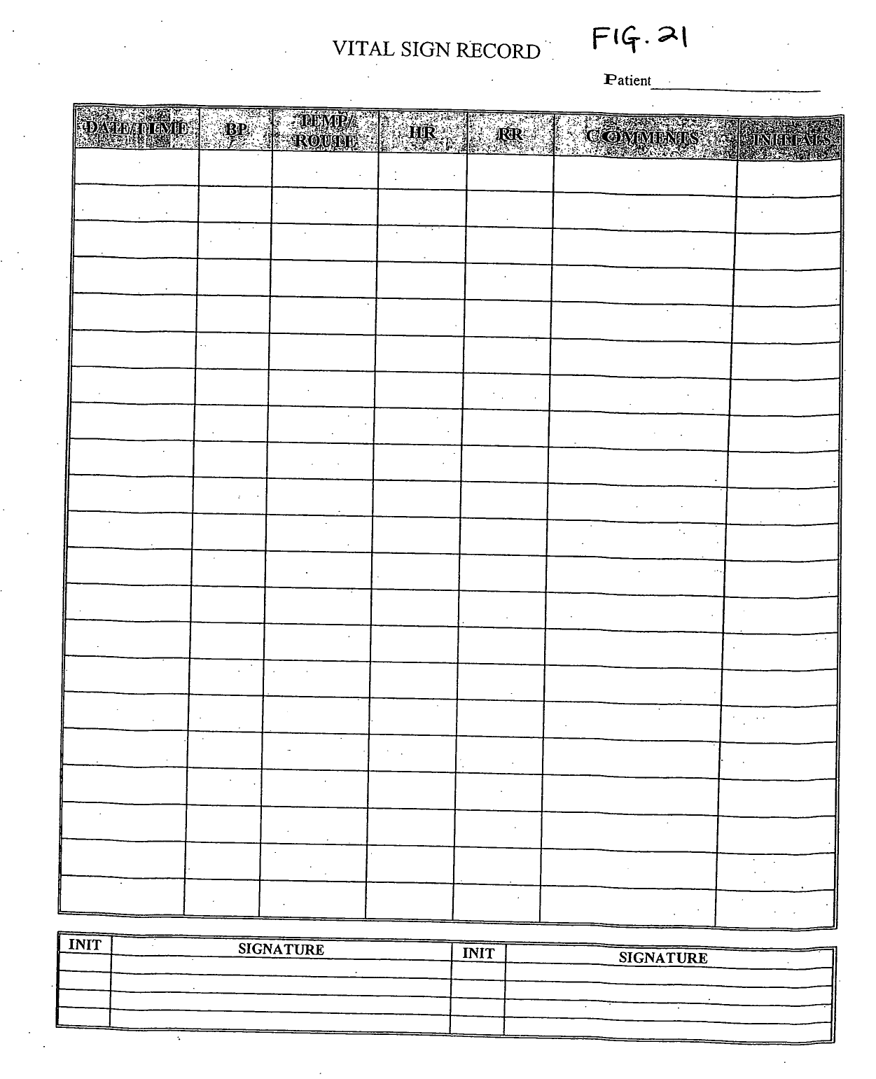

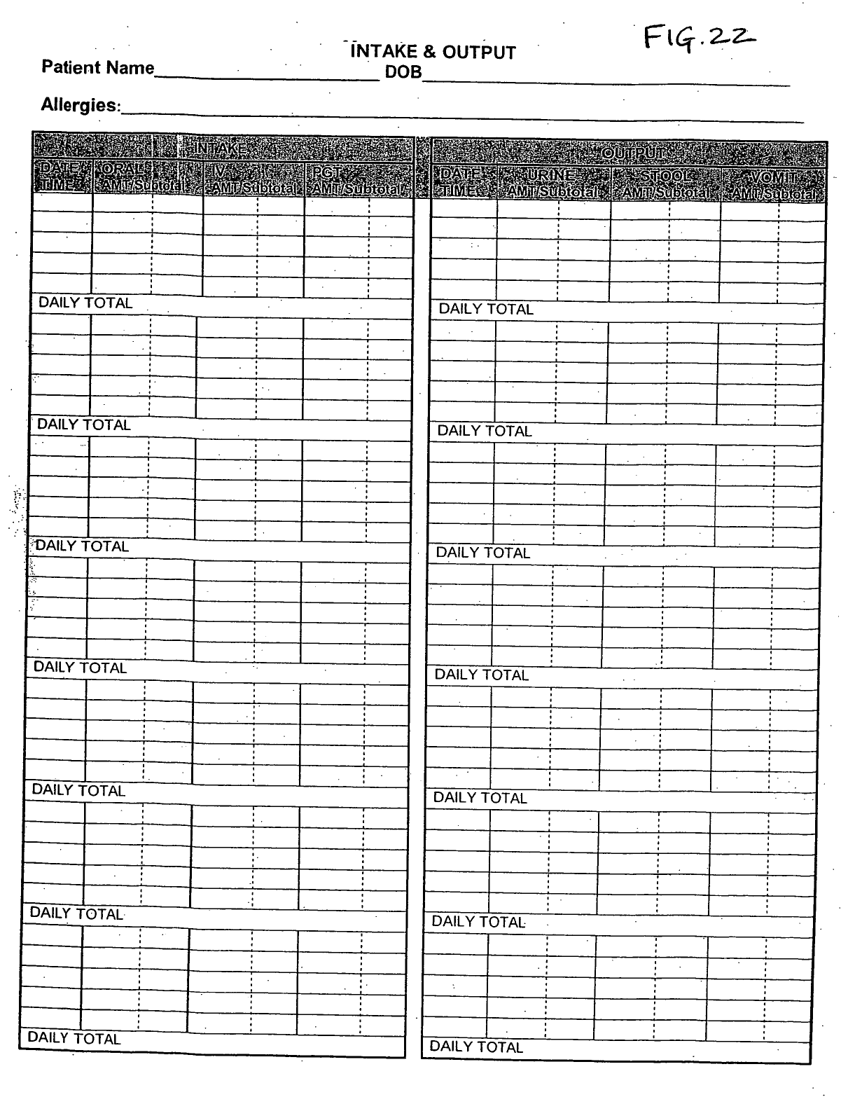

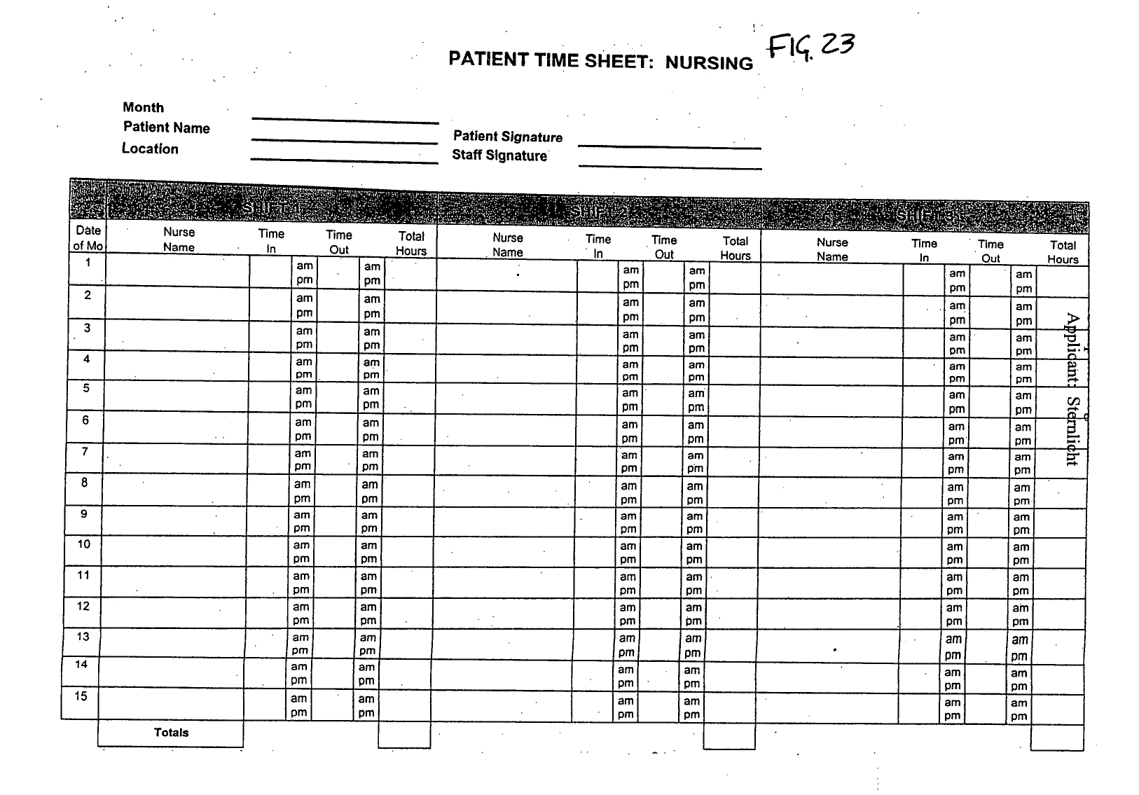

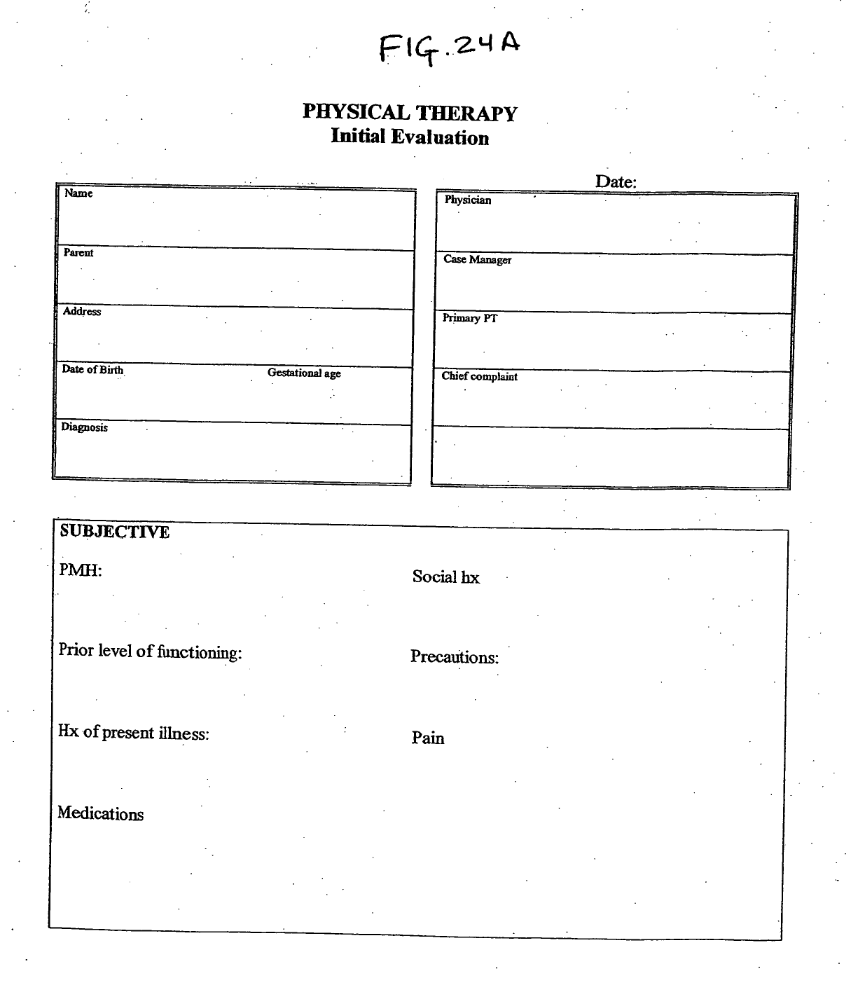

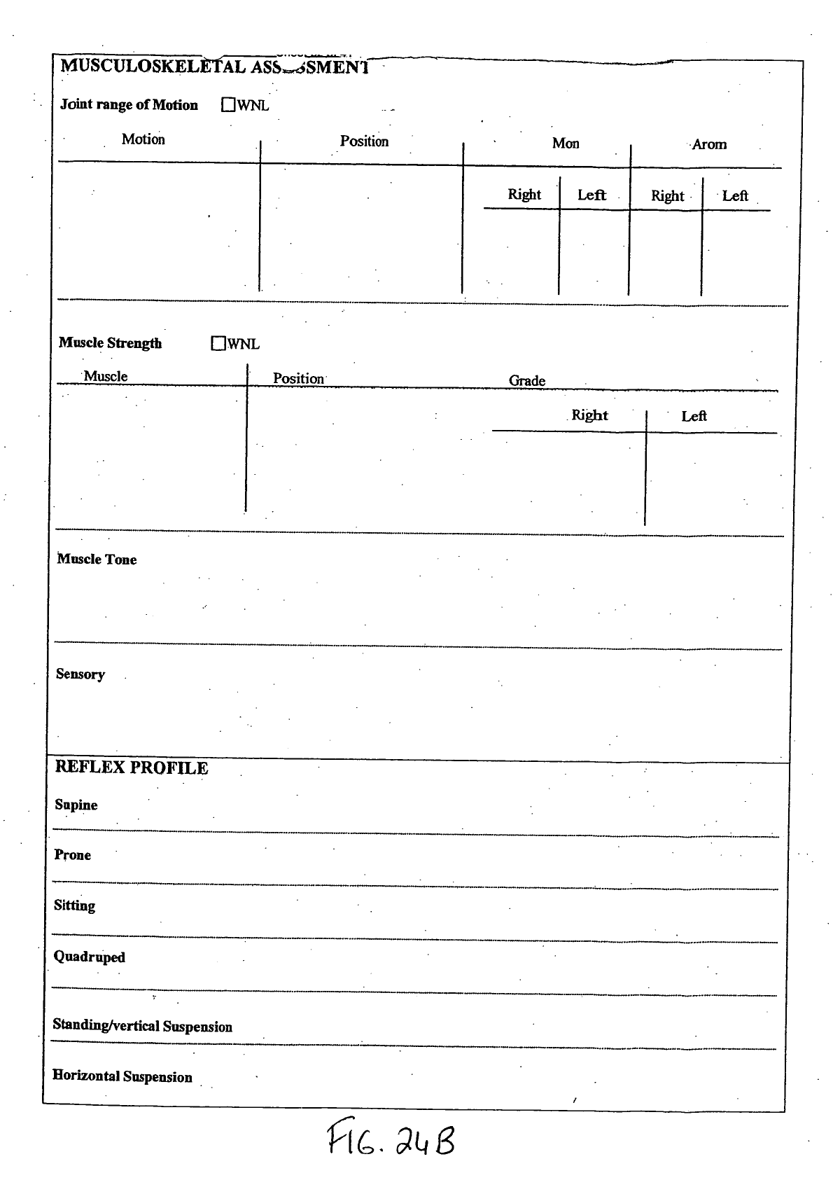

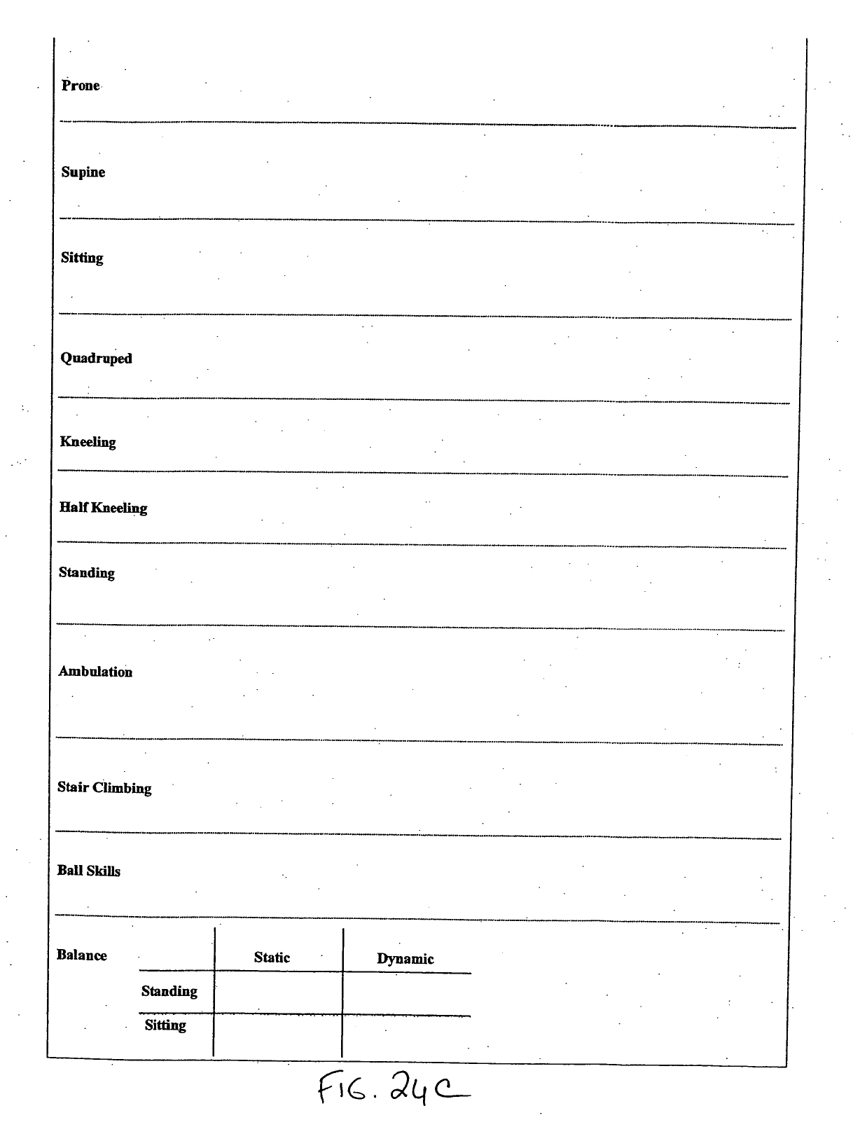

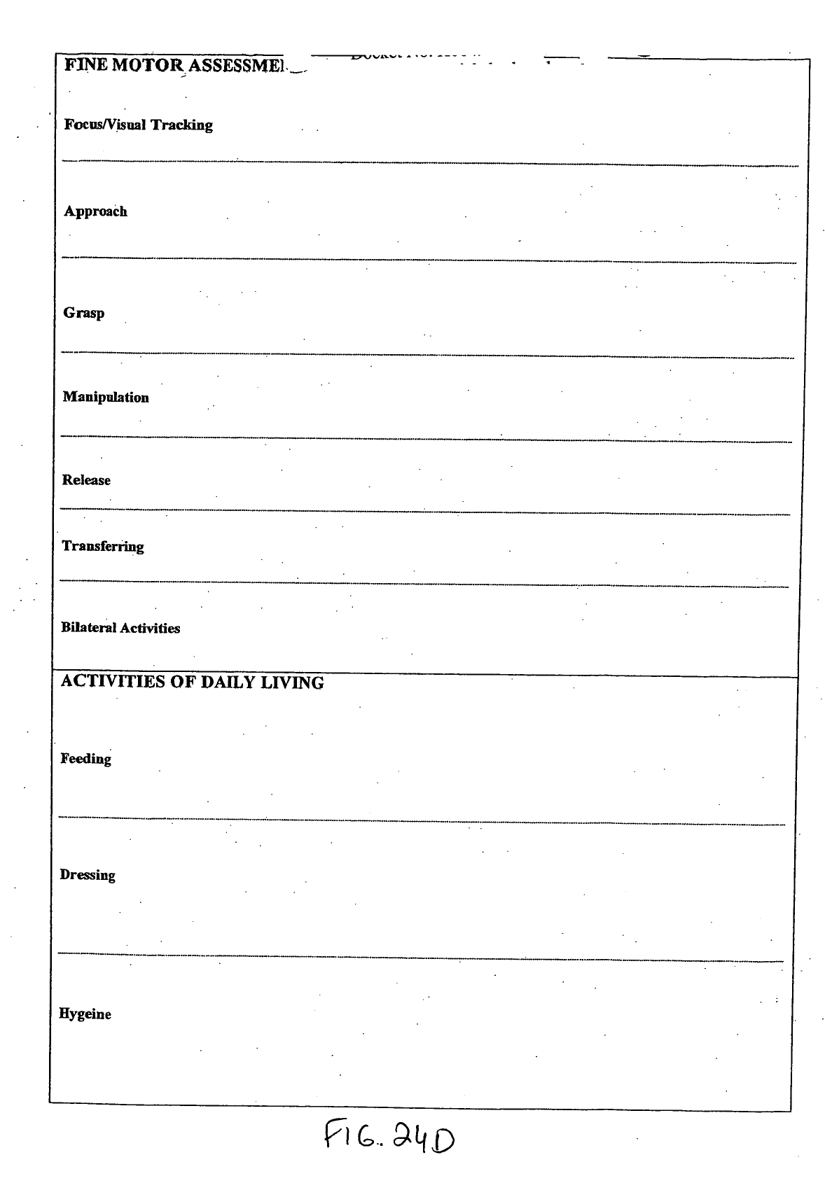

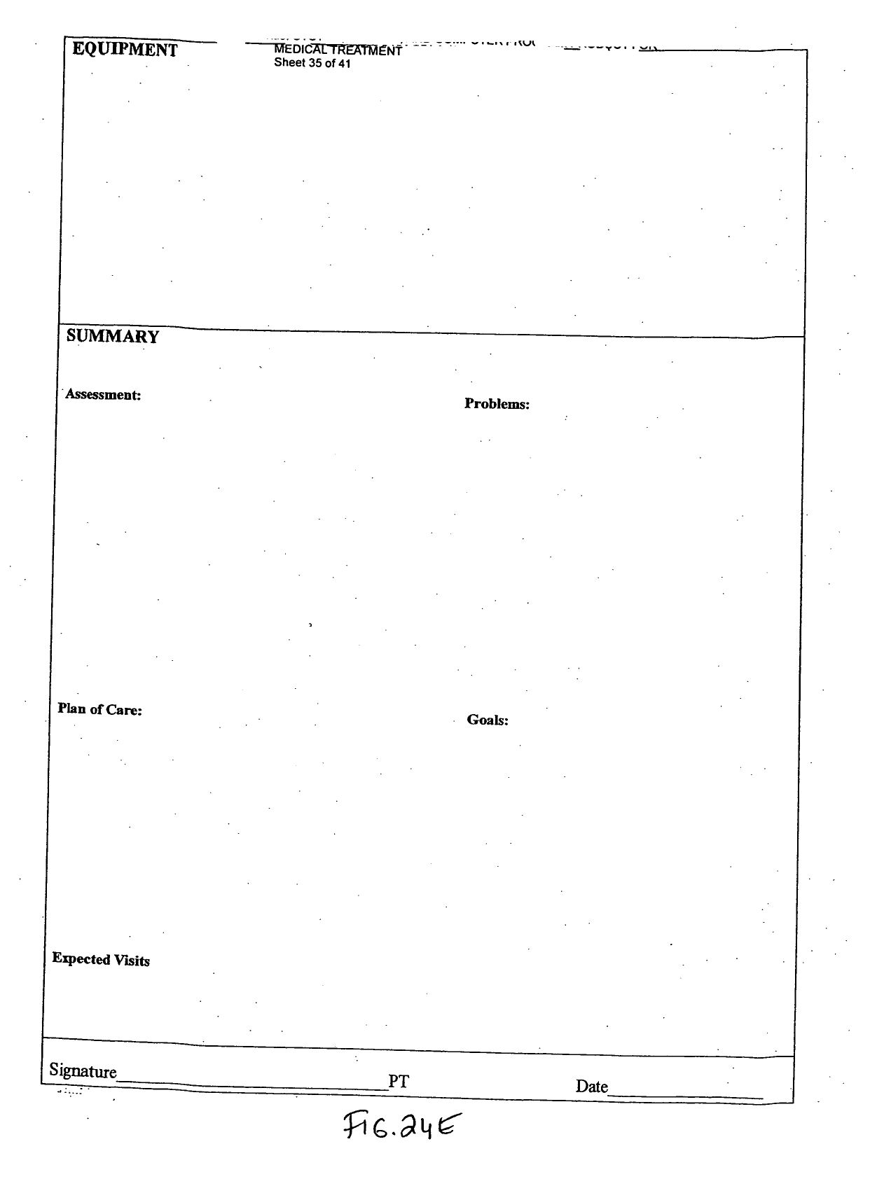

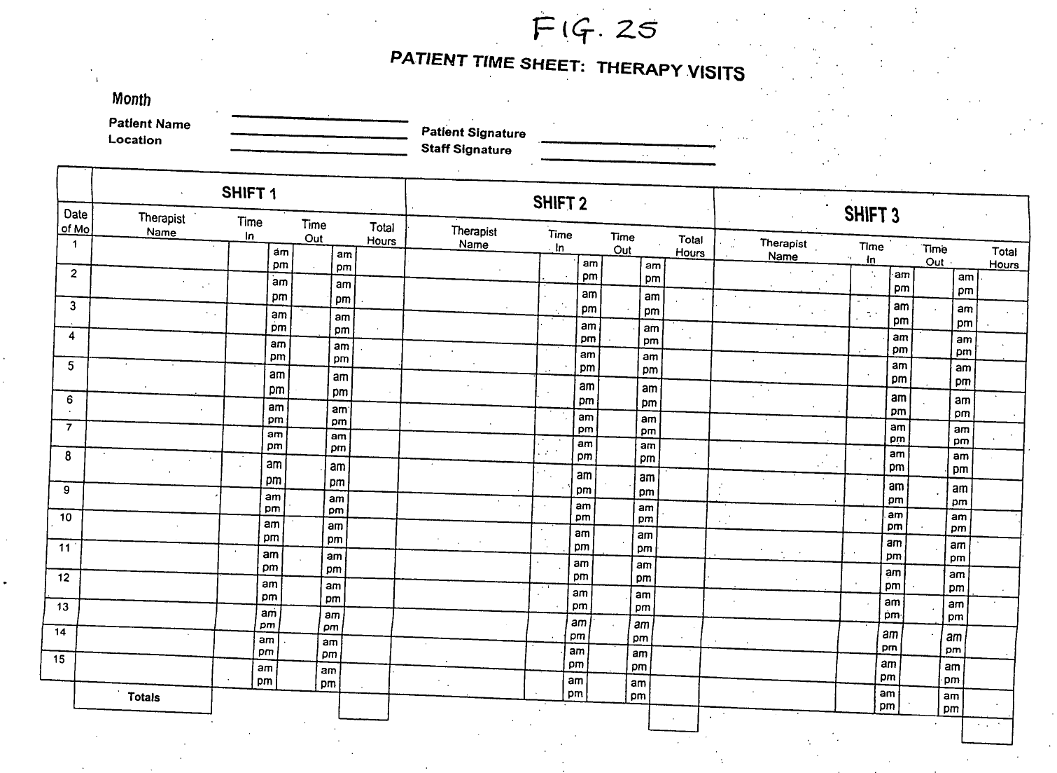

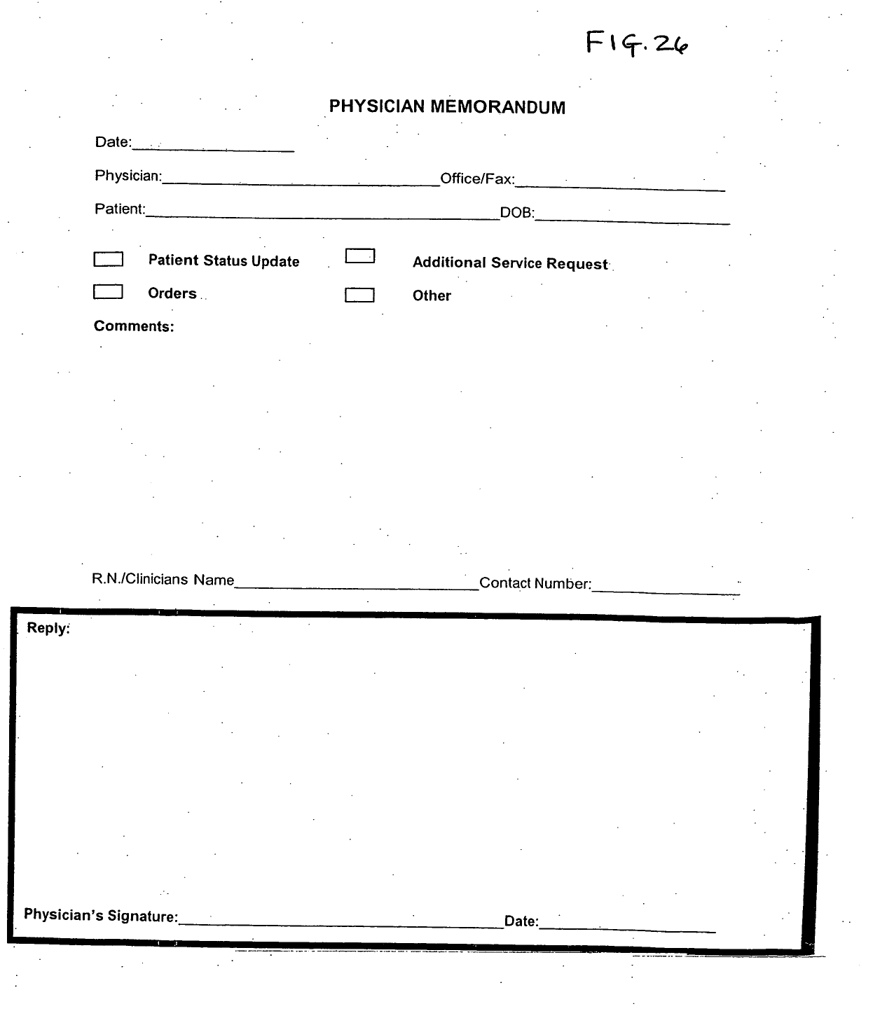

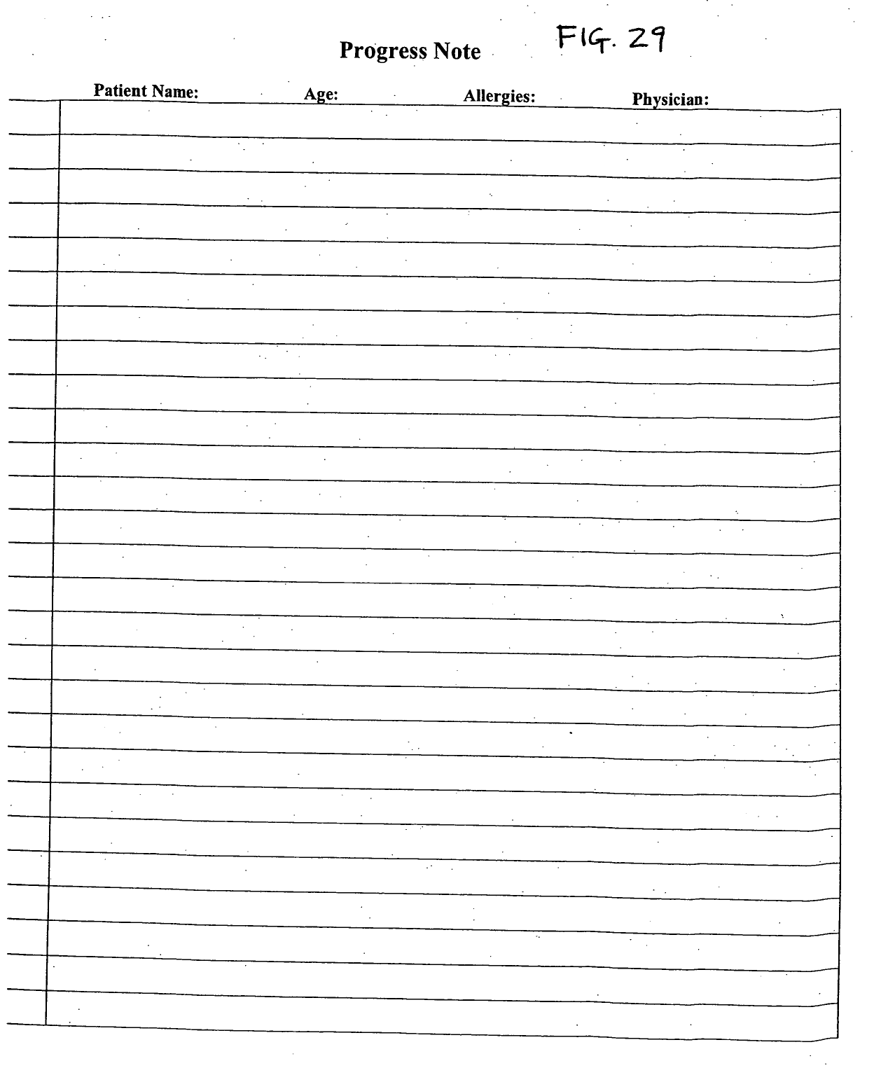

The reporting services include updating the patient chart of services provided and patient status, including specific incident reports. An example template for recording client vital signs is illustrated in FIG. 21. An example template for recording patient intake and output is illustrated in FIG. 22. An example template for recording progress of the client is illustrated in FIG. 29. An example template for recording the time of nursing services provided is illustrated in FIG. 23. An example template for recording therapy services and patient status is illustrated in FIGS. 24A-24E. An example template for recording the time of therapy services is illustrated in FIG. 25. The reporting services may confirm all verbal orders for a change in clinical services, whether to address and emergency or scheduled change in clinical procedures. An example physician order recordation template is illustrated in FIGS. 17 and 26. The confirmation may be sent to the requesting or authorizing physician to confirm the order and/or receive a written authorization of the verbal order. The reporting services may include documentation of the services provided as well as the client status before and after the clinical services. An example template for recording medication prescribed as well as medication given to the client is illustrated in FIG. 18. The reporting services may also inform the method manager, local physician, and/or home physician of any change in the client status and/or indicate a need for change in scheduled clinical services. Clinical services provided by a physician's orders should be clearly documented and/or transcribed in the client's records. The transcribed physician order may be sent to the physician for a written authorization copy to be placed in the client's records. The physician orders may be periodically renewed to ensure proper treatment of the patient. Discharging a client from the clinical services may include providing a client satisfaction survey, assessing client travel on commercial airplane and safety and transportation issues, assessing need for medical escort, assessing need for medical flight to a medical facility, assessing long term resources at the client's end destination including family and support issues and accommodations; assessing medication availability in the country of origin, providing interpreter services for discharge planning, and/or collection of all charts, equipment, and supplies to return to appropriate owner or caretaker such as the patient and/or method manager.

The clinical services provided may be scheduled and/or defined by default protocols or procedures for the clinical personnel or may be specifically ordered by the home physician, local physician, consulting physician, and/or TPA/insurance company through discharge instructions, instructions in response to clinical services already given, or to patient emergency, recovery and/or treatment. These clinical services include, but are not limited to, on-site monitoring and care services; post-procedure wound care including dressing changes, ice application and pain management; pain management through techniques, medication, and procedures; medical supplies; pharmaceuticals; periodic vital signs monitoring as dictated by nursing protocol; psychiatric services and therapy, gourmet food and dietary selection supervised by certified dieticians; specialized rehabilitation and therapy sessions as befits the procedure group, which may include rehabilitation and therapy sessions in hotel provided facilities such as a pool or exercise room; pre-event aesthetician consultation; medical travel escorts; home health aid; therapeutic massage; family respite; after-care products and cosmetics tailored for the post-procedure patient; and access to pre- and post-procedure care information, either in hard copy or electronic versions, by the duty nurse, local physician, home physician, and/or client. These clinical services may be coordinated by the method manager in accordance with instructions from the default protocols, local physician instructions, home physician instructions, and may also accommodate individual patient needs and/or desires.

The inventor has discovered that hotel exercise amenities, such as a pool or gymnasium, are typically used only at particular times during the day by hotel guests. Thus, the exercise amenities are usually underutilized since they stand empty at regular periods during the day. Since these times of non-use are generally fairly regular, the method manager may make private and/or exclusive use of the exercise amenities for scheduling client therapy or exercise sessions.

As part of the clinical services, the method manager may provide default treatment protocols and/or clinical procedures. The protocols and/or procedures may be authorized and or accepted by the local and/or home physician to direct the clinical services to be provided to the client. The default protocols and/or procedures may be certified by an authorized or certifying medical organization. The protocols and procedures may generally provide general and specific information regarding title of procedure, level of personnel to perform the procedure (RN, LPN, HHA, therapist), designated clinical areas, purpose of procedure, policy statements including those noting need for specific doctor's orders, critical elements of procedure, required supplies, tips for procedure and special considerations, preparation and documenting habits for procedure, complication management, patient/family instructions, nurse visiting services plan, applicable support and training references, expert resources, and figures. Example procedures are illustrated in FIGS. 11 A-B and 12A-E. The protocols and procedures may be stored electronically, such as in the treatment database 408, to allow electronic searching for the desired procedure and/or protocol through the method manager and system.

The types of protocols and procedures include, but are not limited to information for family, fever management protocol, routine heparin flush of a capped port of all central venous catheters, G tube site care, home care protocol intravenous fluid administration of total parenteral nutrition and intralipids, administration of medication via nasogastric or jejunostomy/gastrostomy/percutaneous endoscopic gastrostomy (PEG), nasogastric tube care, insertion of oral/nasogastric tube, complications of administering parenteral nutrition, tube feeding management protocol, drawing blood specimens from a central venous access device (CVAD) including all Hickmans, Broviacs, Groshongs, implanted ports, pheresis catheters and central lines, assessing an apical pulse, , assessing blood pressure, assessing the body temperature using a mercury thermometer, assessing a peripheral pulse, assessing respirations, changing an occupied bed, giving a back rub, bathing an adult, blood drawing from a central venous access device, insertion and removal of a foley catheter and catheter care, straight catheterization, central venous catheter dressing change, potential complications of the central catheter, changing the dressing for a central venous catheter, changing the catheter cap, flushing the central venous catheter, routine changing of the central venous catheter cap, routine heparin flush of a capped port of all central venous catheter (ports, Hohn, Groshong, Pheresis, Multiple Lumen Catheters, Hickmans, PICCS), applying wet-to-dry dressings, dry sterile dressing, providing foot care, insertion and removal of a Foley catheter and catheter care, fever management protocol, gastrostomy tube-care, hand washing, removing, cleaning, and inserting a hearing aid, intravenous infusion guidelines for the use of infusion pumps, administration of medication by injection, preparing medications from ampules and vials, administering oral medications, adding medication to intravenous fluid containers, medication administration via nasogastric of jejunostomy/gastrostomy tube/percutaneous endoscopic gastrostomy (PEG), nursing-minimum expectations for home visit, providing oral care, insertion of oral/nasogastric tube, nasogastric tube care, supporting a client in a prone position, turning a client to a lateral or prone position in bed, moving a client up in bed, moving client to the side of the bed in segments, supporting a client in lateral position, supporting a client in dorsal recumbent position, supporting a client in Fowler's position, supporting a client in Sim's position, providing perineal-genital care, providing passive range of motion exercises, establishing and maintaining a sterile field, donning and removing sterile gloves, transcription of medication orders, tube feeding management protocol, giving a bolus gastrostomy (G Tube feeding), giving continuous gastrostomy (G Tube feedings), complication of administration of total parenteral nutrition, and venipuncture for blood sampling.

The method manager may provide specialized training at step 142 to clinical and/or concierge personnel relating to attending clients with particular personal or clinical needs. Such training services may include language, dietary, family support, and/or cultural sensitivity training for foreign clients, such as Russian, Italian, Greek, Japanese, and/or Arab, or religious clients, including Jewish and Islamic. The method manager may also provide medical training for clinical personnel to maintain high clinical service standards or to train for particular specialties or typical after-care scenarios. The clinical training may be certified by an organization as a continuing medical education effort with the awarding of continuing medical educations (“CME”) credits.

The clinical services may be provided through and/or augmented with communication services including, but not limited to, call button capability which may be wireless for near-instant care attention; wireless, Internet, and/or personal communication capability with a physician, including the local physician, the home physician, and/or an on-call physician who may remain available for consultation and management which may be constant and continuous; regular feedback and reporting by the clinical services staff to the referring and/or home physician with teleconferencing “rounding”, e-mail notification, and electronic charting via computing platforms offered to the physician and/or patient; twenty four hour on-line Internet site capability providing patient treatment and recovery information access including specific information from each patient's local or attending physician, home physician, third party administrator (“TPA”)/insurance company, and/or the method manager and links to other recovery sources. Other clinical services offered may include a board of medical advisors to field questions and provide a pool of knowledge if the case is atypical and digital imaging technology through a web site or stand-alone software for visualizing post-operative appearance after cosmetic surgery.

The method manger may also provide electronic or computer access to personal medical records for the clinical service providers, the home physician, and/or the local physician. These medical records may be provided at the time that services are provided or may be kept on file until such a time that after-care or any medical services may be required, such as in time of emergency, including during travel.

The record access may be segmented such that particular parties may access only those relevant portions of the medical status and/or services provided to the client, and may further be limited in the data fields that may be updated or created by the accessing party. For example, the TPA/insurance company and home physician may have access to stored records at steps 130, 132. The accessible recorded information may include, but is not limited to, medical status and clinical services provided to the client to track the recovery process. The TPA/insurance company and/or the home physician may not have the ability to update or change any service or medical information. Even further, the home physician and/or the TPA/insurance company may not access all services provided the client, such as the concierge services. The local physician may have access at step 134 to records including the medical status information and clinical services provided to the patient. The local physician may also have the ability to update the prescribed and/or scheduled clinical services for the client to provide a high level of care and oversight. The local physician may also have access to other services provided to the client to ensure that after-care instructions are met, including, but not limited to, diet, activity, and social well being. The client may have access to the records at step 138, including a record of services rendered and the billing for all services. The client may additionally have the ability to schedule concierge and accommodation services. However, the client may not be able to view his medical status or the clinical protocol in place for his/her treatment or the scheduled clinical services without having requested this access previously from the attending physician or discharging facility. The method manager may have access to all records at step 136, and may also have the ability to update all records. However, the ability to change treatment protocols may be limited or flagged.

The method manager coordinates bookings and reservations of the clients for the packaged and/or bundled accommodation, concierge, and/or clinical services. Bookings may be acquired through marketing efforts of the method manager at step 110 and/or through forming partnerships or service agreements with medical service providers or referral sources 506 at step 140. In one embodiment, at step 140, the method manager may identify particular physician targets, such as those with high-volume practices, leaders in providing opinions, those with appropriate specialties requiring after-care, and/or those with an international client base. The physicians then offer the after-service care opportunity to their patients. The method manager may track the individual physician referrals to the method, and may create and/or modify the service agreements with the individual physicians in response to the number and/or type of referrals. Alternatively or additionally at step 140, the method manager may receive referral reservations from discharge planners at hospitals, nurse managers, floor managers, admitting offices at hospitals, international offices at hospitals, patient surgical and medical financing services for payment of elective procedures, care managers for insurance plans, embassies, patient referral sources, e-commerce medical information sites, or even the hotel itself as an emergency medical service provided for guests at the hotel. Additionally, former clients of the method may act as a referral source for the method.

The hotel itself may be a referral source, referring individuals who are current guests within the hotel when they encounter a medical emergency. Such a package of accommodation, concierge, and/or clinical services may be provided to any guest at the hotel or only those guests participating in a plan, such as through a credit card service or frequent guest upgrade. For example, a credit card may offer a plan to its credit card holders. For example, if the individual uses the BRAND credit card at particular hotel accommodations, he/she will be provided the packaged accommodation, concierge, and/or clinical services at a discounted rate. Moreover, the method manger may prepare and store the medical history and medical records of the individuals in the plan to ensure proper medical treatment in the case of an emergency, such as when the individual is traveling.

The hospital may even outsource care of patients to the method manager if the hospital is over-booked, the hospital needs to shorten the hospital stay, or the patient requires or desires luxury or private services beyond those provided by the hospital. Such options for a hospital in caring for its patients allows the hospital to market to particular clientele. Moreover, since personnel shortages are rampant in the hospital industry, additional offers of care to patients draws upon the limited pool of hospital staffing resources, potentially depriving other patients of needed care. The clinical services of the method may augment or replace services typically provided by the hospital. For example, the clinical services may augment the hospital's lack of care prior to the patient's admittance to the hospital. The method's services may augment hospital care while the patient is in the hospital. Moreover, the last few days of a hospital stay typically custodial, and the clinical care required is minimal, although it is still provided in a hospital environment. The method manager may replace the hospital services at this point and provide accommodation and clinical services to a patient prior to standard or final discharge from the hospital. The services provided by the method manager may be more cost effective than those provided by the hospital, and as such, may be mandated or sponsored by a TPA or payment agency. The outsourced accommodations may be located proximate the hospital in case of complications.

In one embodiment of the invention, the manager may accept reservations for services at a particular time for a particular number of patients in a particular geographical location. At step 124, the method manager may bundle the reservations into a quantum bundle 512, preferably in a quantum of four. The period of services for the bundled clients may be identical or overlapping in time. For example, the manager may accept a first patient's reservation and allow the patient to choose his hotel or accommodation of preference from the available accommodations 502. The next three patients for that locale and approximate time may then be restricted by the manager for that first accommodation selection to ensure a bundle of four patients for that accommodation, concierge, and clinical services provided to the patients through the method and system. The next reserving patient may then be allowed to choose the accommodation of her preference, and the following three reservations may be similarly limited for that location. Although this example is described with a quantum of four as the more preferable quantum bundle for a single duty nurse, any quantum number may be set according to particular agreements with service providers and/or costing considerations regarding bundling of services.

The method manager schedules the reservations for packaged accommodations, concierge, and clinical services at steps 118, 120, 122. These reservations may be made directly with the client, through the referral source 506, or local physician 508. The method manager, after scheduling the accommodations with the hotel, may schedule the concierge services in step 120 in accordance with the agreement between the client and the method manager, and any stated client preference. The method manager also may schedule, at step 122, the clinical services in accordance with the treatment protocol which may be a default treatment protocol provided by the method manager, or may be provided and/or updated by the local physician and/or the home physician of the client.

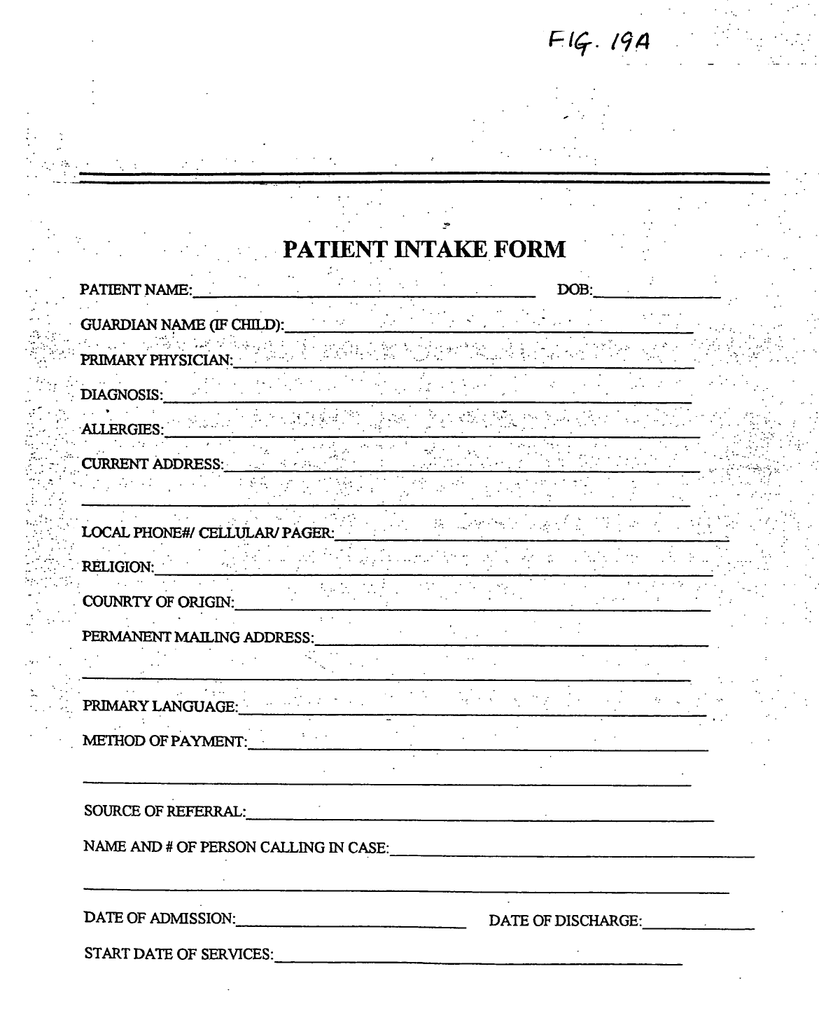

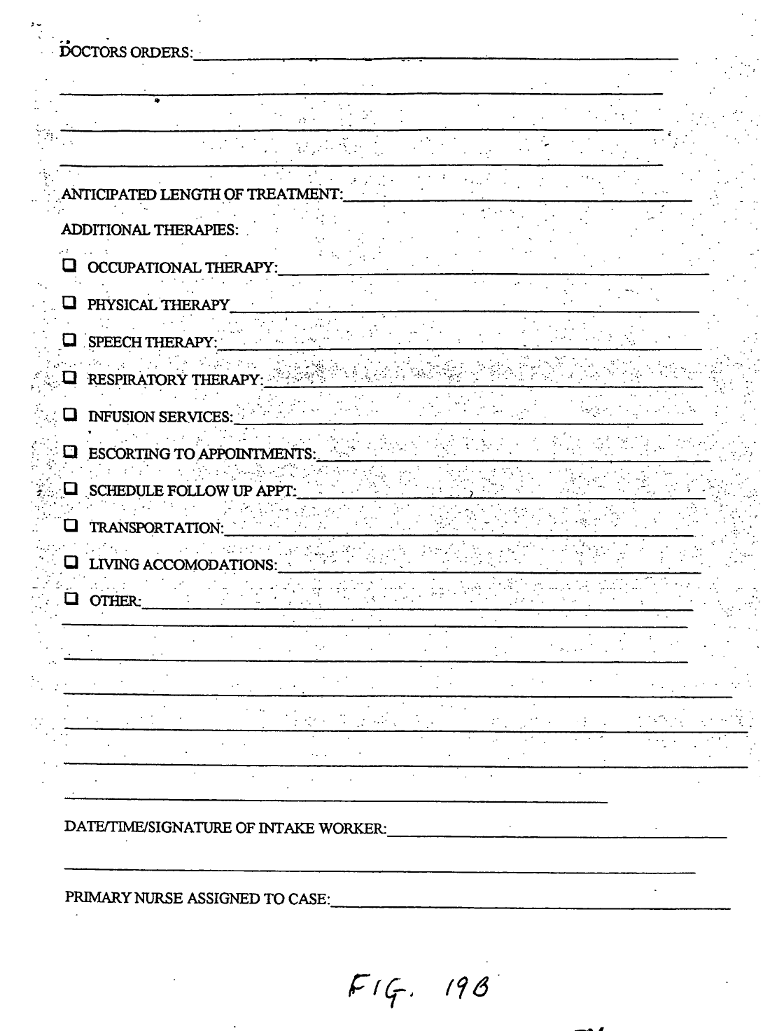

In one embodiment of the invention, the clinical personnel may institute a referral intake visit with the client. The clinical personnel may visit or communicate with the client in the referring medical facility to ensure a smooth discharge. The clinical personnel may collect patient information. An example patient intake form is illustrated in FIGS. 19A and 19B. The clinical personnel may introduce herself to the inpatient floor and/or the client's nurse; review the nursing referral; assure there is an order for all skilled therapies, medications, phlebotomy and follow-up appointments on the referral intake from and authorized by the physician as necessary; gather the names of all physicians involved in the client's care including their specialty, primary physician, office number, pager and request for follow-up appointments as applicable; request the floor nurse to send that patient home with 2-days of supplies and/or medication as allowed; obtain copies of the nursing referral and prescriptions; and/or confirm the patient's means of transportation (own transportation, nursing escort, ambulance, chair car, airlines) to the method accommodations and/or the client's home. The clinical personnel may then introduce herself to the patient and discuss the services available under the method and those appropriate for the patient's medical condition and clinical care including visit times, length of visit, all skilled therapies to be involved in care, and teaching of the patient for following care. The clinical personnel may then discuss the billing procedure and offer to discuss any concerns of the client. The clinical personnel may then record the information in the intake template and submit the intake information to the method manager.

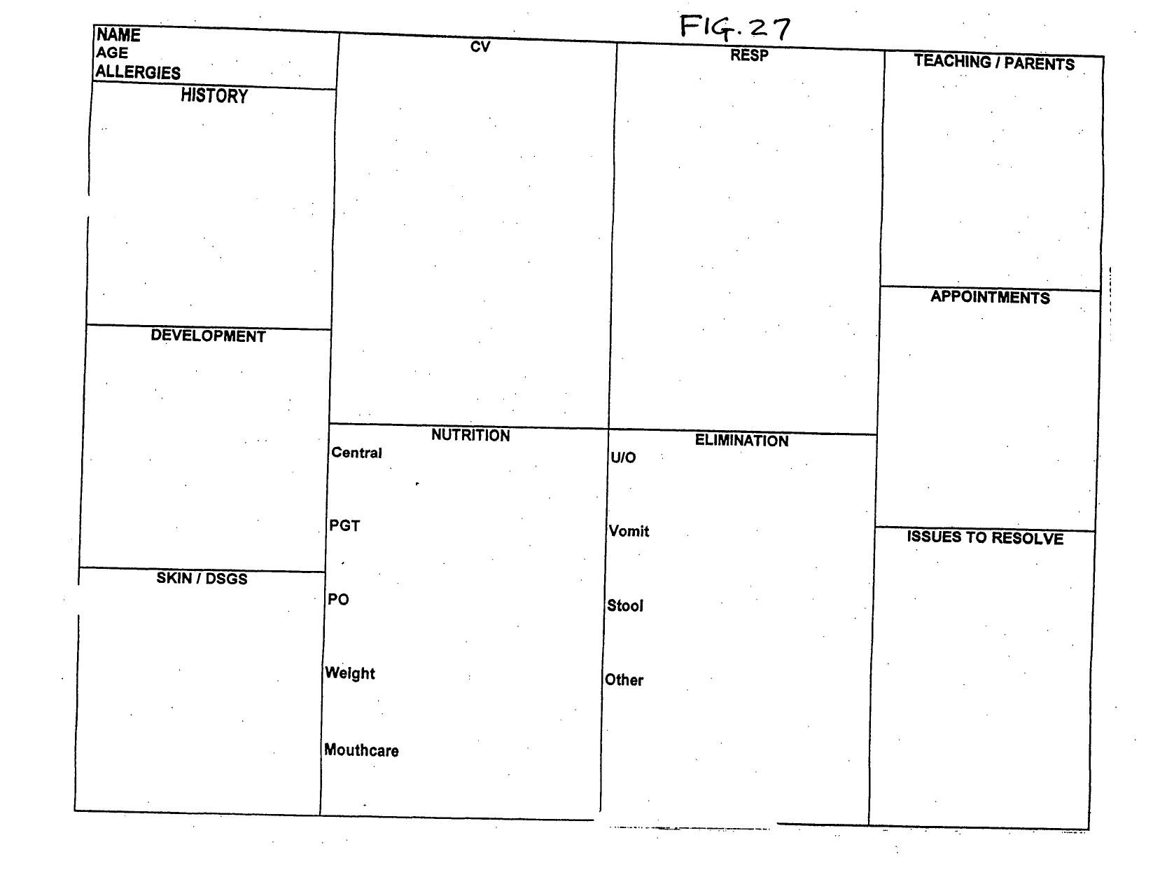

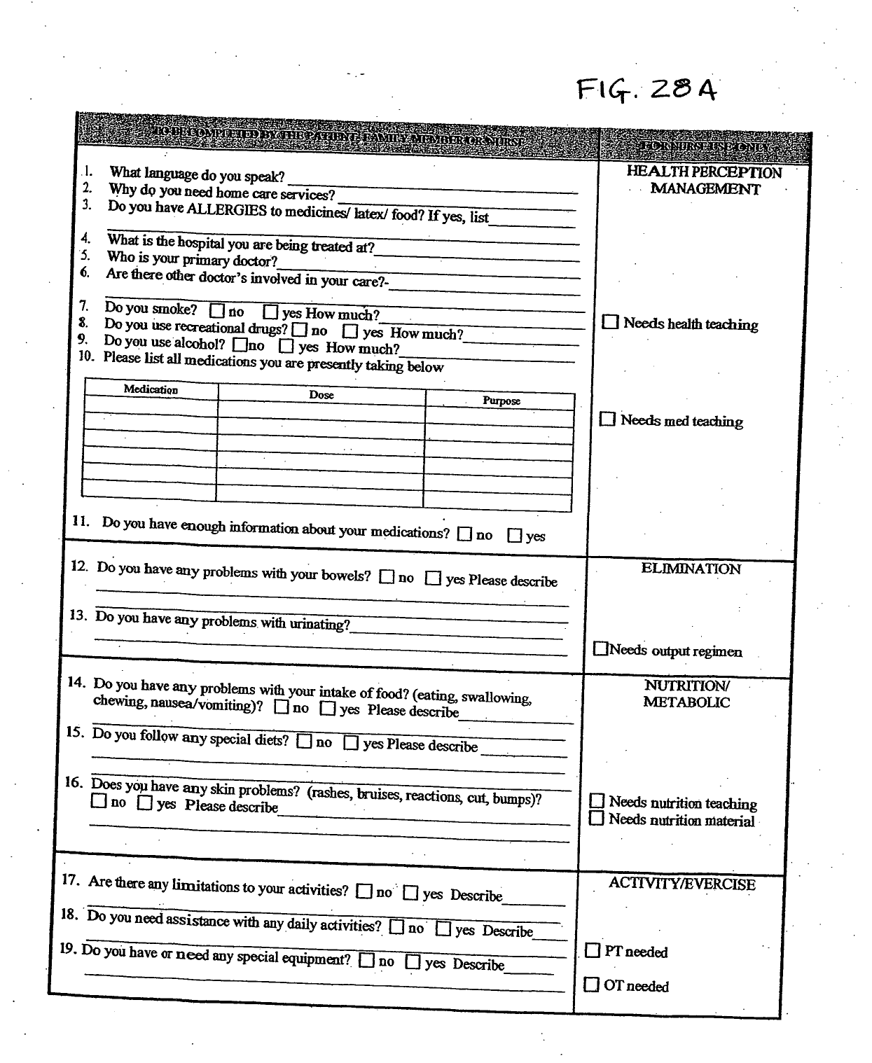

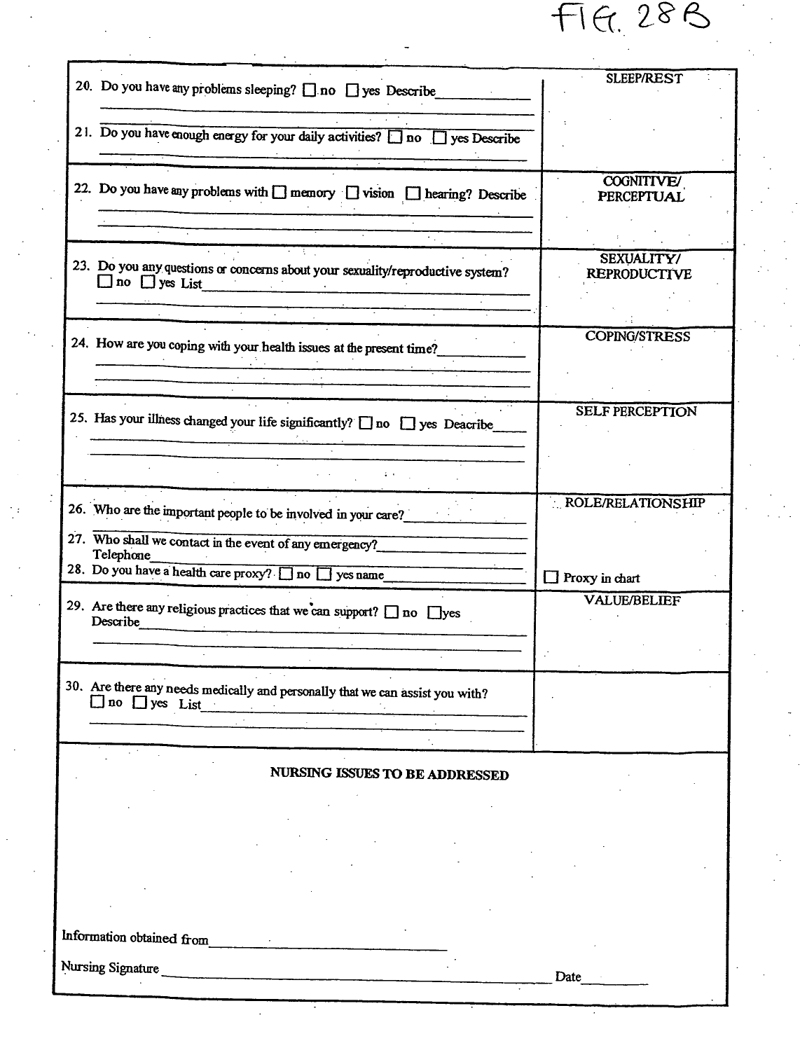

The method manager then provides the packaged accommodation, concierge, and clinical services in steps 104, 106, 108. The method manager may transfer control of provision of particular concierge services to the hotel or independent concierge personnel, such as the provision of particular rooms, food, spa services, valet services. Personnel of the method manager, which in one embodiment is the clinical personnel, may conduct an initial visit with the client. The initial visit may address any questions or confusion of the client and her family after discharge from the medical facility, fully asses the patient, design the plan of care with the client and family, reinforce the discharge instructions and teaching, and assure the client has all needed supplies, medications and support. The collection of patient information may include, but is not limited to, performing a verbal and/or physical exam of the patient, perform an assessment of the accommodations and make or suggest necessary changes with the client as needed, review all medications with the patient and family and compare the medications on the referral with what the client has already filled and/or not filled. Designing the plan of care may include identifying skilled needs of clinical personnel and documenting the initial plan of care. Identifying and implementing patient education needs may include medication teaching with the family including drug name, purpose, dose, route of administration, times of administration and side effects, home care teaching regarding management of the client, and equipment teaching as necessary. Assurance of necessary supplied may include identifying and listing all needed supplies and medications if one has not been generated, assuring the patient has all necessary supplied and medication at the accommodations, obtaining all needed supplies as necessary, and having prescriptions filled as needed. Checking equipment may include testing all equipment for proper functioning, teaching the family and client on the proper use of the equipment, and assuring there is an equipment manual in the accommodations for all equipment. The personnel may also confirm all scheduled appointment with the patient and with the physician's office, thoroughly document the assessment, plan of care, and teaching, and communicate the recorded information to the method manager. Example templates for recording the initial visit information are illustrated in FIGS. 27 and 28A-28B.

At step 128, the method manager and/or service personnel then records the services provided to particular clients and records the time, cost, and/or materials used. In scheduling the services and in recording provision of the services, the method manager may trace the material, personnel, and/or equipment required to provide that service at the designated time or to restock central or individual supply inventories to maintain a sufficient amount of material on hand. In tracking the services provided, the method manager may coordinate billing to the client at step 126. The manager of the method may hire or contract management and staff in a central location or alternatively in each city or even hotel where the services are provided including operations managers, valets, nurses, therapists, and aestheticians. The manager may then manage reservations, scheduling and provision of services on a local, national, and/or international level.

The service agreement for the providers of referrals may provide incentives at step 114 for the number of referrals and/or for the length or amount of services provided for each referred client. These incentives may include, but are not limited to renumeration of value, reduced-rate or upgraded luxury room and board, reduced rates for patients, referral fees, rebates of a portion of sales of after-care related products or cosmetics, benefits at professional meetings and/or focus groups, and/or equity positions in the method manager.

Each provider of the method services may bill the client directly for services rendered, or preferably, the method manager coordinates billing to the client at step 126, either at the end of service or periodically throughout the service period. More preferably, the method manager bills the local or home physician, such that the patient is only presented with a packaged bill for services for the medical procedure/hospital care and services under the method. Thus, the patient may pay only one or a series of bills through the individual's physician office that may include the physician's services pre- and post-procedure as well as the post-procedure recovery services available through the method, and the procedure costs including anesthesia and facility costs.

To facilitate managing and providing the method, the method manager may use a client care system 300 which may embody and/or facilitate the software based system shown in FIG. 3. The client care system 300 preferably includes a billing manager 302, a reservation manager 304, a scheduling manager 306, a services manager 308, and an incentives manager 310, all of which may be present and operating on one more computers or other devices acting as a server computer for the system. Although the function/processes of the client care system are described in a particular order, the various operations need not be performed sequentially or in the order described. The processor computer, herein called a client care processor 301, may be accessed by one or more computers or other devices used in any manner known in the art (e.g., via the Internet) by those with an interest in the level of care and recovery, including, but not limited to, the method manager 200, clients 500, referral sources 506, hotels 502, clinical personnel 504, concierge personnel 510, local and attending physicians 508, TPA/insurance companies 516, and/or home physicians 514.

The method manager 200 may be coexistent with or interconnected to the client care processor 301 through one or more computers, devices, and/or interfaces in any manner known in the art, including the Internet or server protocols and devices. The client care processor may then be accessed by the method manager 200 from a remote or separate location with a communication system which, in one embodiment, is a typical Internet browser. For example, the method manager may access an applicable log on web page by inputting the applicable uniform resource locator (“URL”). The method manager may then input a user name and password to proceed and may thereafter enter or edit (1) available accommodations 502 under existing partner agreements, (2) referral source information, (3) reservations of clients, (4) bundled reservations, (5) schedule of accommodations, (6) provision of accommodation services, (7) schedule of concierge services, (8) provision of concierge services, (9) schedule of clinical services, (10) provision of clinical services, (11) record of services provided, (12) billing for services, and (13) incentives for referrals. The input or edited information may be transmitted by the method manager in any number of ways, including, but not limited to, any data or signal discernable by the client care system 300 as method data, such as a message in any format of any computer protocol. For example, any suitable interface, such as an HTML form may be used to permit the user of the client care system to create or update method information. This may take place well before the method manager of the client care system provides any services or even receives any reservations for services, may occur as part of the provision of the services, may occur after services are provided, and/or may occur periodically or in real-time.

The existing accommodation information may be a name, code, title, location specific identifier, or other unique identifier of the accommodation information and may also include preset pricing policies and/or room types and availability.

The referral source information may be recorded on a worksheet or template. An example referral template is shown in FIG. 10. The referral source information may include a referral source name, location, address, contact information, key personnel, type of patient, volume of patient, services required of the method manager, special needs, referral process, marketing process, training process, and relationship building. The referral source name may be a title institution name, or any unique identifier of the referral source. The location may be metropolitan identifier, city name, or any unique identifier of the location of the referral source. The address may be a postal address, street, city, sate, and/or zip code identifying the address of the referral source. The contact information may be a telephone number, facsimile number, URL, or any unique identifier of how to contact the referral source. The key personnel may be a name, title, position, or unique identifier of the referral source key personnel and/or the method manager key personnel. The type of patient identifier may be a name, type, medical specialty, procedure, clinical grouping or other unique or descriptive identifier of the type of patient. The volume of patient identifier may be a number, rate, percentage or other unique identifier of the volume of anticipate patients from the referral source. The services required of the method manager identifier may be a title, name, or description of the general or specific types of packages or bundled accommodation, concierge, and/or clinical services. The special needs identifier may be a name, title or description of the special needs of typical or expected clients from the referral source. The referral process may be a description of the method or process by which the referral source will refer clients to the method. The marketing process may be a description of the method or process by which the referral source will market the method to potential clients. The training process may be a description of the method or process by which referral source personnel will be trained to manage the provide the method. The relationship building may be a description of the method or process by which the referral source personnel will build relationships with their clients.

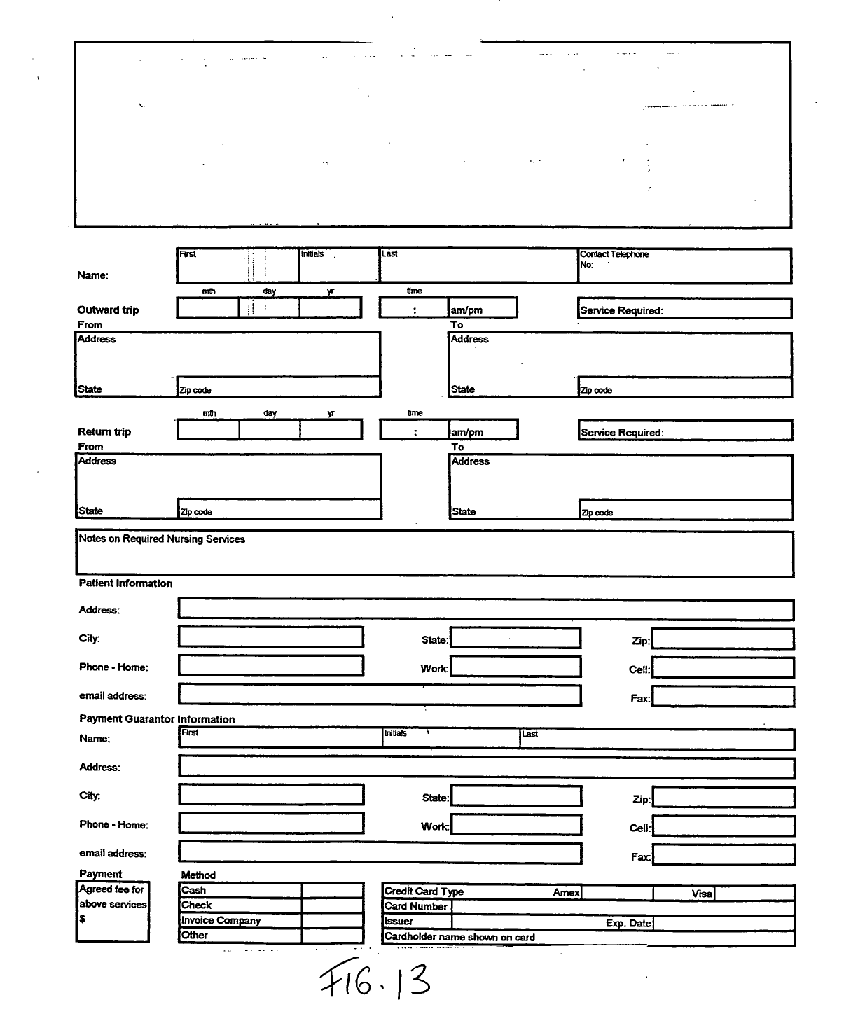

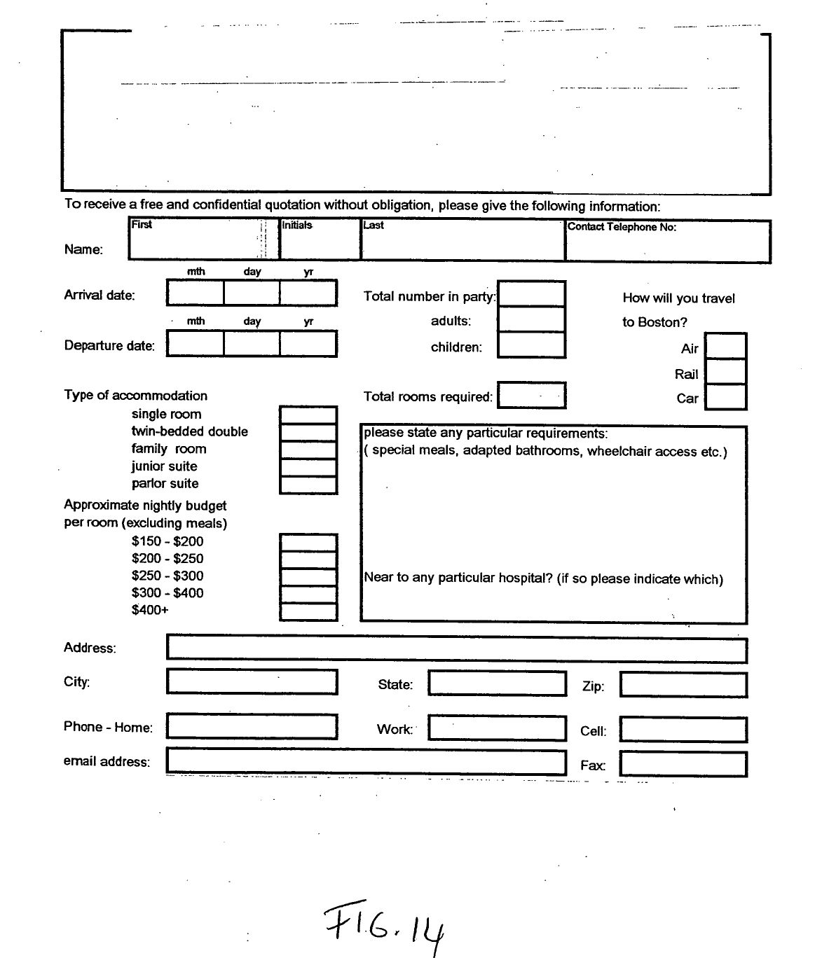

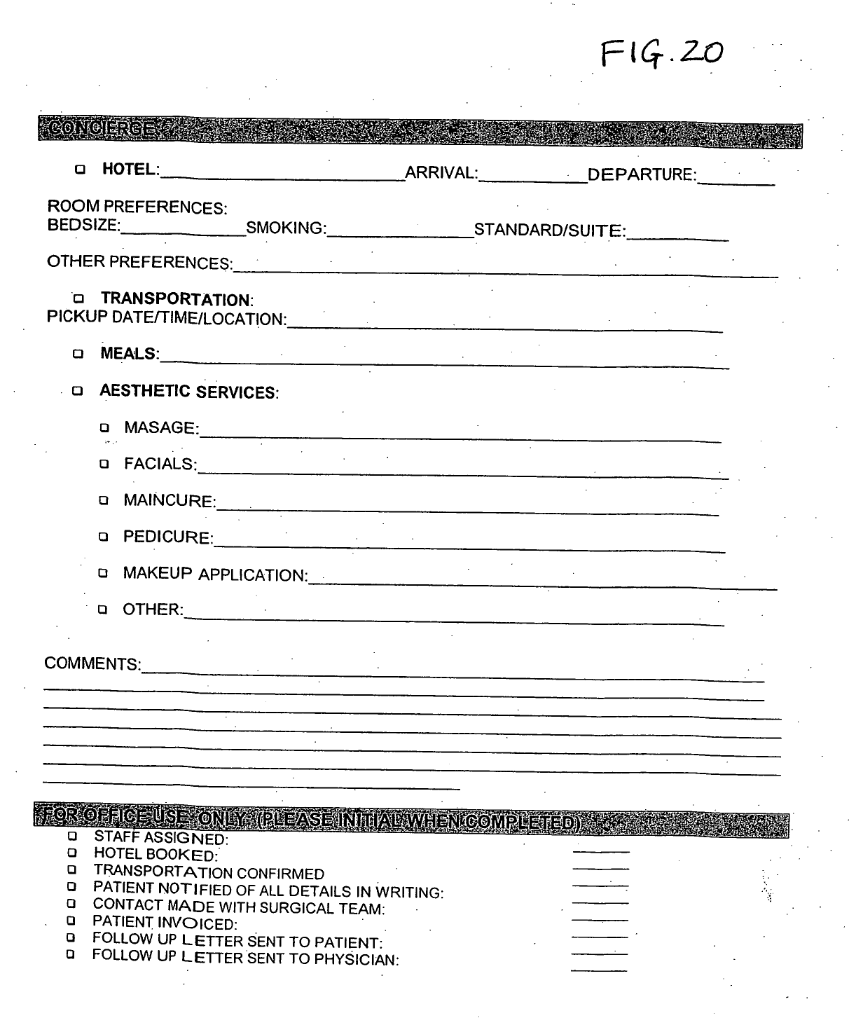

The reservation information may include a patient identifier, patient name, patient address, patient date of birth information, patient gender information, geographical location identifier, medical facility identifier, local physician identifier, local physician contact information, TPA/insurance company identifier, home physician identifier, home physician contact information, expected start date identifier, expected stop date identifier, expected length of stay in accommodations, medical procedure or care identifier, accommodation preferences, concierge services preferences, personal emergency contact information, billing status identifier, referral source identifier, and/or reservation identifier. An example template for recording reservation information for travel concierge services is illustrated in FIG. 13. The travel information may include a patient identifier, patient address, patient contact information, date and time of outward trip, a concierge service identifier, an initial starting address, an initial destination address, a returning starting address, a returning destination address, and payment information including method (cash, check, invoice company, credit card) and payment guarantor identification and contact information. An example template for recording accommodation information is shown in FIG. 14. Accommodation information may include the patient identifier, patient address, patient contact information, estimated arrival date, estimated departure date, total number in client party including adults and/or children, type of travel to and from accommodations, accommodation type identifier such as single, twin, family, junior suite or parlor suite; number of rooms requested, and any particular requirements such as special meals, adapted bathroom, wheelchair access, and proximity to particular medical facilities. Example template for recording reservation information are shown in FIGS. 15-16B. Reservation information may include the date the information taken, the referral source identifier, referral source contact information, the patient identifier, patient address, patient contact information, patient date of birth, diagnosis or procedure to be treated, brief medical history and/or allergies, estimated length of stay, referring hospital and specific floor/unit/room of the discharged client, surgeon or local physician identifier, local physician contact information, services to be provided, dates and hours of services, payment information including method (cash, check, invoice company, credit card) and payment guarantor identification and contact information, prescriptions of be filled/delivered identifier, medical supplies needed, equipment needed, accommodation services identifier including hotel preference or price range, number of rooms, number of occupants, arrival date and time, estimated departure date and time, room type preference, transportation services including nurse escort via car or plane, wheelchair accessible van, ambulance, or limousine with pick up time, date and location, concierge services including massage, facial, manicure, pedicure, makeup application, and/or hair services, and any special requests. The reservation information may be accompanied by a discharge order and instructions from the medical facility. An example template for concierge services is illustrated in FIG. 20. The concierge service information may include accommodation services identifier including hotel preference or price range, number of rooms, number of occupants, arrival date and time, estimated departure date and time, room type preference, transportation services including nurse escort via car or plane, wheelchair accessible van, ambulance, or limousine with pick up time, date and location, concierge services including massage, facial, manicure, pedicure, makeup application, and/or hair services, any special requests, and the personnel assigned or scheduled to provide the services, and the confirmation of scheduled services. The patient identifier may be a name, code, title, social security number, or other unique identifier of the patient or client. The patient name information may include the actual given name of the client, or a pseudonym. The patient address may be the postal or home address and/or telephone number for the client or any unique identifier of the contact or home information of the client. The patient date of birth information may include the age or date of birth of the client or other unique identifier of the patient's date of birth. The patient gender information may be a name, code title, or other unique identifier of the gender of the client. The geographical location identifier may be a name, code, title, location specific identifier, or other unique identifier of the geographic location for the anticipated recovery or care of the client. The medical facility identifier may be a name, code, title, or other unique identifier of the medical facility initially treating the patient during the procedure or medical treatment prior to the client entering the method services. The local physician identifier may be a name, code, title, or other unique identifier of the local physician. The local physician contact information may be a postal address and/or phone number or other unique identifier providing contact information for the local physician. The TPA/insurance company identifier may be a name, code, title, or other unique identifier of the TPA/insurance company managing care of the client and/or supplementing payment of the client care services. The home physician identifier may be a name, code, title, or other unique identifier of the home physician. The home physician contact information may be a postal address and/or phone number or other unique identifier providing contact information for the home physician of the client. The expected start date identifier may be a date, code, or other unique identifier of the anticipated start date of the client entering the method. The expected stop date identifier may be a date, code, or other unique identifier of the anticipated stop date for the provision of services to the client under the method. The expected length of stay in accommodations identifier may be a period of time given in days and/or months, a code, or other unique identifier of the expected length of stay of the client in the method accommodations. The medical procedure or care identifier may be a name, code, title, or other unique identifier of the medical affliction or procedure for which the client may require treatment. The accommodation preference may be a name, code, title, location specific identifier or other unique identifier of the preferential accommodation information requested by the client. The concierge services preferences identifier may be a name, code, title, or other unique identifier of the available concierge services preferred or requested by the client. Personal emergency contact information may be a name, address, phone number or other unique identifier for emergency contact information in the case of emergency with the client. The billing status identifier may be a name, code, or other unique identifier of the status of the current bill for the individual client and/or the type of billing requested which may indicate real time, periodic, or end of services billing to be made through the method manager, the local physician, and/or the home physician. The referral source identifier may be a name, code, title, or other unique identifier of the referral source of that particular client reservation. The reservation identifier may be a name, code, or other unique identifier of that particular reservation for that particular client.

The client care system 300 stores this information in a patient database 400, a referral source database 402, and/or a services database 404. After the method manager reserves a client to a particular geographical location for a particular time, the method manager or the client care system 300 may bundle the reservations. The method manager may manually review reservation times to find opportunities to bundle clients into the same accommodation to bundle the packaged services. Alternatively, the client care processor 301, through the reservation manager 304 software system, may automatically determine opportunities to bundle clients and/or limit the reservation process available to force bundling opportunities. For example, after a first reservation, following reservations may be limited to the accommodations of the first reservation to force a bundle of clients until the quantum number of clients within a bundle have been achieved. Each bundle of clients receiving clinical services and concierge services in the same geographical location at the same time, are provided accommodation services at the same accommodation location in the particular quantum bundle 512.

After bundling the reservations as much as possible in the preferred quantum bundles, the method manager or the client care system may automatically or manually schedule accommodation services with the existing accommodations in the geographic locations. The method manager may reserve the accommodations, or alternatively, the reservation manager may automatically reserve the accommodations with access to the hotel reservation system. The method manager and/or the client care system may update the patient database and/or the services database to indicate scheduled accommodations and/or bundle identifier for each patient. The bundle identifier may be a name, code, or other unique identifier of the group of clients bundled together in a particular quantum.

The method manager, the client care system, and/or the accommodations/hotel may schedule concierge services before the client even enters the process of the method and/or during the patient's stay in the accommodations provided as determined by the method or in accordance with client preferences or requests. After concierge services are scheduled and/or provided, the method manager, hotel accommodations, and/or client care system through the schedule manager software system may manually or automatically access and update the patient database and/or the services database. Similarly, the method manager and/or client care system may automatically or manually schedule clinical services in accordance with patient preferences, treatment protocols designated by either the method manager, local physician and/or the home physician. After the clinical services are provided, the method manager, client care system and/or clinical personnel 504 may manually or automatically record the clinical services provided and patient medical status information into the patient database and/or the services database. For example, the clinical personnel may record the clinical services and medical status onto a paper template which may be transcribed to be electronically stored by the services manager software system in the approximate databases. Alternatively, the clinical personnel may record the information electronically, such as in a palm computing device. The information may then be transmitted in real-time or periodically to the services manager and electronically stored in the appropriate databases.

In one embodiment of the invention, the clinical personnel may deliver the clinical services to the patient and record the services rendered and the patient's medical status in a palm computing device 518. Other applicable methods and devices known in the art may also or alternatively be used to record and/or transmit service and/or medical status information. Medical status information recorded by clinical personnel is well known in the art and includes, but is not limited to, vital signs, subjective information, compliance with medication and/or treatment instructions, problems with medications, social issues, support issues, and mobility/activity of the patient. Patient and services information may be automatically or manually transmitted by the palm computing device in or through any number of data formats or messages, including, but not limited to, any data or signal discernable by the client care system 300 as patient and/or services data, such as a message in any format of any computer communication protocol. The information may be transmitted in real-time as the information is input by the clinical personnel, such as over a wireless cellular system or land line connection, and/or the information may be transmitted or downloaded at the end of each service period. For example, the clinical personnel may place the palm computing device in a docking station located in each patient's room at the end of each service period for that particular patient, or alternatively, the docking station may be centrally located for each duty nurse or clinical personnel. In an alternative embodiment, the palm computing device may have wireless capabilities, such that when data is entered into the palm computing device, the device then transmits that information forward to the client care processor.

Based on the services provided, the processor 301 may calculate the billing for the services provided and/or may determine the materials required to restock any material provided in the clinical services, such as medications, dressings, equipment, and other medical supplies. The billing and/or restocking calculations may be done in real time or periodically throughout the provision of services.

The services data and patient data may be made available to the method manager 200, the client 500, the hotel 502, the clinical personnel 504, the referral source 506, local physician 508, the concierge personnel 510, the home physician 514, and the TPA/insurance company on a segmented or secure access basis, for example through a code or password protected web site on the Internet. Moreover, each accessing individual may be limited in the information that may be viewed and/or updated. Thus, the people providing the services, those directing the provision of services, and those tracking the services provided may manage and oversee treatment from a remote location while maintaining confidential information of the client. The local or attending physician may track progress of the patient and adherence of the patient to the protocols, and modify the treatment and/or care protocols in response to that information in near real-time. To access patient data, the local physical may provide a password to access the databases of the client care processor. The local physician may access the patient medical status and history, clinical services, and/or concierge services to monitor the patient. The local physician may also update information in the medical status and/or scheduled clinical services in response to the patient's medical status. The home physician may track progress and communicate that data to the patient's family as designated by the patient. The client care processor 301 may request a password to access information. The home physician password may provide access to patient medical status information and clinical services information. The home physician may not change any of the data fields accessed, and may not access data fields pertaining to concierge services and/or billing information. The TPA/insurance company can manage the care of the patient more effectively from a remote location. The TPA/insurance company may have password access to limited information, including the medical status of the patient, clinical services provided, and billing information. Like the home physician, such access may be read-only, and as such, the TPA may not change or update any data fields. On the other hand, the TPA may communicate in near-real time, which services and treatments may be covered or supplemented by the patient's medical coverage plan. The method manager may track the services provided and prescribed and further schedule the provision of those services and coordinate the billing. The free flow and completeness of the patient, services and billing information enables fully-informed consensus based decisions to better treat the patient.

The method manager and/or client care system may determine or calculate the incentives due for referrals given by a particular referral contact. That information may be stored in a referral source database 402. The incentive information may include a referral source identifier associated with other incentive information, defined by the agreement between the method manager and the referral source. The incentive information may include, but is not limited to, the length of stay of the client, type of services provided, including accommodation services, concierge services, and/or clinical services, the cost of the services provided including accommodation services, concierge services, and clinical services, and/or an incentive identifier. The incentive identifier may be a name, code, title, or other unique identifier of the type of incentive to be provided which may include a monetary amount, type of reduced rate or upgraded luxury room and board, reduced rate for patients, referral fees, rebates and portions of sales of after-care related products or cosmetics, benefits at professional meetings and/or focus groups, and/or equity positions in the method manager.

The client care processor 301, shown in FIG. 4, may include one or more communication ports 600, one or more processors 602, an internal data and time clock 604, and storage 606 which includes one or more computer programs 608, defining instructions which once executed, instruct the computer to perform the operations of the billing manager, reservation manager, scheduling manager, services manager, and incentives manager. The storage may also include the patient database 400, a referral source database 402, a services database 404, and a product database 406, and any other database applicable to the medical treatment and accommodation of the present method and system. These programs and these databases will now be described in more detail in connection with FIGS. 5-9.

FIG. 5 illustrates an example table 610 for a patient database 400, which includes one or more records 612. In general, each record associates the patient identifier 614 with a reservation code 616, and optionally, additional information about the identified patient. In this example, each record 612 includes patient identifier 614, patient name 618, patient address 620, geographical location for treatment and/or after care 622, medical facility identifier 624, local physician identifier 626, local physician contact information 628, TPA/insurance company identifier 630, home physician identifier 632, home physician contact information 634, expected start date identifier 636, expected stop date identifier 640, expected length of stay and accommodation 642, medical procedure or care identifier 644, an accommodation preferences identifier 646, concierge services preferences 648, personal emergency contact information 650, billing status identifier 652, referral source identifier 654, bundle identifier 656, reservation identifier 616, patient birth date 658, patient sex identifier 638, patient allergies 739, anniversary of the procedure/recovery 660, default after care protocol and notes 662, prescribed after care protocol and notes 664 and/or medical record information 666. Entries in the patient data base are made as clients 500 make reservations for accommodation, concierge and/or clinical services under the method and may be added or modified by the method manager 200, the hotel 502, the clinical personnel 504, the referral source 506, the local physician 508, concierge personnel 510, the home physician 514, and/or the TPA/insurance company 516.

FIG. 6 illustrates an example Table 668 for a referral source database 402, which includes one or more records 670. In general, each record associates a referral source identifier 654 with a reservation code 616, and optionally, additional information about the identified referral contact. In this example, each record 670 includes a referral source identifier 654, referral source name 672, referral source contact information 674, billing type information 676, billing status information 652, incentive information 680, client patient identifier information 614, medical procedure or care identifier 644, incentives received identifier 678, incentives due identifier 682, and referral information 683, including the number of referrals, total bill of referrals, and/or actual or average bill of referrals. Entries in this database are made as referral sources register with the method manager as described above and/or refer clients to the method manager. After a physician or referral contact registers with the method manager, individual reservation information and/or billing and incentive information may be added or modified by the method manager.

FIG. 7 illustrates an example Table 684 for a services database 404, which includes one or more records 686. In general, each record associates the patient identifier 614 with a service code 688 and service provider identifier 690, and optionally additional information about the identified patient and/or service provider. In this example, each record 686 includes a patient identifier 614, patient name 618, the reservation code 616, bundle identifier 656, service type identifier 692 identifying the type of service as accommodation, concierge or clinical, service provider identifier 690 identifying the individual or group providing the service, a time identifier 694 identifying the length of time of providing the services, date identifier 696 identifying the date the services were provided, cost identifier 698 identifying the cost to the patient of the services provided, and a billing status identifier 652 indicating the status of whether that particular service has been billed or unbilled and the status of payment of the bill. Entries in this database may be made as hotels, concierge personnel, and/or clinical personnel provide services to each individual patient and/or patient bundle. Alternatively, and/or additionally, the method manager may update the service database.

The method manager may also offer after-care products and cosmetics for sale directly to the clients and/or the local or home physicians. Such products may be hosted at a web site of the client care system 300 and may be electronically accessible by the client and/or a physician over the Internet. FIG. 8 illustrates an example Table 700 for a product database 406, which includes one or more records 702. In general, each record associates the product identifier 704 with a product price 706, and optionally, additional information about the identified product and product provider. In this example, each record 702 includes a product identifier 704, a product price 706, an availability identifier 708 identifying the availability or prospective shipment of the product, a list of product ingredients 710, prescribed uses for the product 712, a medical procedure or treatment identifier 644, and provider identifier 714 identifying the manufacturer or distributor of the product. Entries in this database are made by the method manager and are accessible through the client care system 300 by the clients and their physicians.

The method manager may also offer specific post-procedure and treatment protocol instruction and medication templates, assisted by aids. Such templates and aids may be hosted at a web site of the client care system 300 and may be accessed by a client's local and/or home physician and/or the TPA/insurance company. FIG. 9 illustrates an example Table 720 of a default treatment database 408, which includes one or more records 722. In general each record 722 associates a medical procedure or treatment identifier 644 with a medication type identifier 724, medication dosage identifier 726, treatment type identifier 728 identifying the type of treatment recommended, and a treatment practice identifier 730 identifying the practice and timing of the treatment, and optionally, additional information about the treatment or care protocol. Treatment or care protocols are well known in the art and may be phased for different periods of treatment, tailored for particular circumstances, age groups, sex of the patient, and other factors affecting treatment or care of the patient.

Each database may be any kind of database, including a relational database, object-oriented database, unstructured database or other database. Example relational databases include Oracle 8i from Oracle Corporation of Redwood City, Calif.; Informix Dynamic Server from Informix Software, Inc. of Menlo Park, Calif.; DB2 from International Business Machines of Yorktown Heights, N.Y., and Access from Microsoft Corporation of Redmond, Wash. An example object-oriented database is ObjectStore from Object Design of Burlington, Mass. An example unstructured database is Notes from the Lotus Corporation of Cambridge, Mass. A database also may be constructed using a flat file system, for example by using files with character-delimited fields, such as in early versions of dBASE, now known as visual dBASE from Inprise Corporation of Scotts Valley, Calif., formerly Borland International Corporation. Notwithstanding these possible implementations of the foregoing databases, the term database as used herein refers to any data that is collected and stored in any manner accessible by a computer. The databases and individual records may be accessible by only authorized personnel to retain the confidentiality and security of the information. The database may be secured and/or code/password protected. Additionally, the databases may be compliant with information and format protocols known in the industry, including, but not limited to, Joint Committee on Accreditation of Healthcare Organizations (JCAHO), Outcome Assessment and Information Set (OASIS), and Health Insurance Portability and Accountability Act (HIPAA). Additionally, the data stored in the database may be sorted and/or searchable to augment services to the client.

Having now described the databases maintained by the care processor in this embodiment, the various operations performed by the care processor will not be described. Referring to FIG. 1, those operations include, but are not limited to, booking reservations of the clients 112, bundling the reservations 124, scheduling accommodations 104, scheduling concierge services 120, scheduling clinical services 108, recording services provided 128, coordinate billing for the services 126, providing incentives for referrals 114, accessing database by TPA/insurance company 130, accessing database by home physician 132, accessing the database by the local physician 134, accessing the database by the method manager 136, accessing the database by the client 138. The various operations in FIG. 1 need not be performed sequentially or in the order shown. These various operations will now be described in more detail.

Referring to FIGS. 2 and 3, a patient 500 may reserve services through a referral source, a local physician, and/or directly with the method manager. The reservation manager 304 may provide an open electronic template to be filled with reservation information, as shown in FIGS. 13-16B, or alternatively, the reservation manager may provide sequential prompts to be answered. Each answer may then determine the next prompt for information. For example, if the patient is the first client in a quantum bundle, they may be prompted for their preferential accommodation. However, patient reservation times and locations maybe compared to the first patient information by the reservation manager to determine any opportunities to bundle clients and services. A bundled client may be offered accommodation services only at the accommodations reserved for the first patient. Otherwise, the reservation manager may access the services database, product database, and/or default treatment database to offer a complete package of services to the client. The reservation manager may then bundle the accommodation reservations as much as possible to limit the number accommodation locations for the accommodation, concierge, and/or clinical personnel. The reservation manager then stores the patient information in the patient database, the referral source information in the referral source database, and/or the reservation information in the incentive database.

The scheduling manager may then automatically schedule the accommodations, concierge, and/or clinical services as accessed from the services database as directed by the default protocol as accessed from the default treatment database, instructions from the local physician, instructions from the referral source, instructions from the home physician, or as directed by the client. In addition to scheduling the services, the scheduling manager may also schedule the personnel to provide the scheduled services and/or designate appropriate authorities to provide the services, such as the hotel staff.

The personnel then provide the scheduled services and record the data regarding services rendered and patient medical status. Any of the templates shown in FIGS. 17-29 may be electronically provided as an open template. Alternatively, the services manager may prompt the personnel for the type of information that they are recording, and provide further tailored prompts or templates. The services manager then stores the services information in the services database, product database, and the patient database as services are provided to the patient.

The care processor may then determine the billing for the services provided. The billing manager may access the patient database, referral source database, product database, and/or services database to determine the services provided to the patient as well as pricing and cost considerations. The billing manager then calculates the bill for each individual client. The bill for services may be presented to the client, TPA/insurance company or may be presented to the local physician, referral source, or home physician to be packaged into the services provided by the local physician, referral source, or home physician. The bill may be presented periodically through the treatment period or at the end of the treatment period. Additionally, the billing may be calculated and/or accessed in near real time by the patient, local physician, referral source, home physician, and/or TPA/insurance company to regulate and/or monitor the expenses of treatment.

The incentives manager may calculate the incentives due to the referral source based on the services provided, billed, and/or paid. The incentives manager may access the patient database, the referral source database, product database and/or services database to determine the services provided, pricing and cost considerations, volume of business, and/or incentive agreement considerations between the referral source and the method manager. The software may be a stand-alone system or be part of an interactive web-site available on a global communication network. The system or method may be implemented as software resident on an interactive web site providing universal or local reservation and scheduling of bundled services, provide pricing information regarding services and service levels available, local to international availability of hotels and services, and pre- and post operative information. Alternatively or additionally, the method may be embodied as a billing software system that bundles the reservation and costing of the services and distributes those bundled costs to the participating physicians and patients.

A computer system with which the various elements of the post recovery system of FIGS. 1 and/or 2 may be implemented either individually or in combination typically includes at least one main unit connected to both an output device which displays information to a user and an input device which receives input from a user. The main unit may include a processor connected to a memory system via an interconnection mechanism. The input device and output device also are connected to the processor and memory system via the interconnection mechanism.

One or more output devices may be connected to the computer system. Example output devices include cathode ray tubes (CRT) display, liquid crystal displays (LCD) and other video output devices, printers, communication devices such as a modem, storage devices such as a disk or tape, and audio output. One or more input devices may be connected to the computer system. Example input devices include a keyboard, keypad, track ball, mouse, pen and tablet, communication device, and data input devices such as audio and video capture devices. The invention is not limited to the particular input or output devices used in combination with the computer system or to those described herein.

The computer system may be a general purpose computer system which is programmable using a computer programming language, such as C, C++, Java, or other language, such as a scripting language or even assembly language. The computer system may also be specially programmed, special purpose hardware, or an application specific integrated circuit (ASIC). The physician and/or patient device also may be a pager, telephone, personal digital assistant or other electronic data communication device.

In a general purpose computer system, the processor is typically a commercially available processor, of which the series x86 and Pentium series processors, available from Intel, and similar devices from AMD and Cyrix, the 680X0 series microprocessors available from Motorola, the PowerPC microprocessor from IBM and the Alpha-series processors from the former Digital Equipment Corporation, and the MIPS microprocessor from MIPS Technologies are examples. Many other processors are available. Such a microprocessor executes a program called an operating system, of which WindowsNT, Windows 95, 98, or 2000, IRIX, UNIX, Linux, DOS, VMS, MacOS and OS8 are examples, which controls the execution of other computer programs and provides scheduling, debugging, input/output control, accounting, compilation, storage assignment, data management and memory management, and communication control and related services. The processor and operating system defines a computer platform for which application programs in high-level programming languages are written.

A memory system typically includes a computer readable and writeable nonvolatile recording medium, of which a magnetic disk, a flash memory, and tape are examples. The disk may be removable, known as a floppy disk, or permanent, known as a hard drive. A disk has a number of tracks in which signals are stored, typically in binary form, i.e., a form interpreted as a sequence of one and zeros. Such signals may define an application program to be executed by the microprocessor, or information stored on the disk to be processed by the application program. Typically, in operation, the processor causes data to be read from the nonvolatile recording medium into an integrated circuit memory element, which is typically a volatile, random access memory such as a dynamic random access memory (DRAM) or static memory (SRAM). The integrated circuit memory element allows for faster access to the information by the processor than does the disk. The processor generally manipulates the data within the integrated circuit memory and then copies the data to the disk after processing is completed. A variety of mechanisms are known for managing data movement between the disk and the integrated circuit memory element, and the invention is not limited thereto. The invention also is not limited to a particular memory system.

Such a system may be implemented in software or hardware or firmware, or any combination thereof. The various elements of the system, either individually or in combination, may be implemented as a computer program product tangibly embodied in a machine-readable storage device for execution by a computer processor. Various steps of the process may be performed by a computer processor executing a program tangibly embodied on a computer-readable medium to perform functions by operating on input and generating output. Computer programming languages suitable for implementing such a system include procedural programming languages, object-oriented programming languages, combinations of the two, or any now known or later developed programming languages.

The invention is not limited to a particular computer platform, particular processor, or particular high-level programming language. Additionally, the computer system may be a multiprocessor computer system or may include multiple computers connected over a computer network. Various possible configurations of computers in a network permit many users to participate in an auction, even if they are dispersed geographically.

Each module or step shown in the accompanying figures and the substeps or subparts shown in the remaining figures may correspond to separate modules of a computer program, or may be separate computer programs. Such modules may be operable on separate computers or other devices. The data produced by these components may be stored in a memory system or transmitted between computer systems or devices. The plurality of computers or devices may be interconnected by a communication network, such as a public switched telephone network or other circuit switched network, or a packet switched network such as an Internet protocol (IP) network. The network may be wired or wireless, and may be public or private.

Having now described a few embodiments, it should be apparent to those skilled in the art that the foregoing is merely illustrative and not limiting, having been presented by way of example only. Numerous modification and other embodiments may be made. For example, the packaging of accommodation, concierge, and/or clinical services and/or bundling of patients may be applied to any provision of medical care, whether within the home and/or through a medical facility.

What is claimed is:

1-35. (canceled)

36. A method for providing interim care to hospital patients before final discharge, comprising the steps of:
a) outsourcing hospital patient interim accommodation to non-medical accommodations before final discharge;
b) outsourcing clinical services for medical treatment of the hospital patient;
c) providing accommodation services for the patient at a non-medical accommodation; and
d) providing clinical services to the patient at the none-medical accommodation.

37. The method as claimed in claim 36, wherein the hospital patient includes a plurality of patients.

38. The method as claimed in claim 36, further comprising transferring the patient from the medical facility to the accommodation with a supervising professional medical escort.

39. The method as claimed in claim 36, wherein after the step of providing medical services to the patient, the method further comprises the step of facilitating final discharge from the hospital.

40. The method as claimed in claim 36, wherein the non-medical accommodations include short term guest based accommodations located proximate the hospital.

41. The method as claimed in claim 36, wherein the step of outsourcing interim accommodation and outsourcing clinical services are mandated by a third party administrator.

42. The method as claimed in claim 36, wherein the steps of providing accommodations services and providing clinical services are provided at a lower overhead cost than accommodation and clinical services in a hospital.

43-63. (canceled)
